(19) United States
(12) Patent Application Publication
(10) Pub. No.: US 2013/0021349 A1
(43) Pub. Date: Jan. 24, 2013

(54) DISPLAY DEVICE, LIQUID CRYSTAL MODULE, AND IMAGE DISPLAY SYSTEM

(71) Applicant: Yukihide Kohtoku, Osaka-shi (JP)

(72) Inventor: Yukihide Kohtoku, Osaka-shi (JP)

(73) Assignee: SHARP KABUSHIKI KAISHA, Osaka-shi, Osaka (JP)

(21) Appl. No.: 13/638,175

(22) PCT Filed: Nov. 1, 2010
(86) PCT No.: PCT/JP2010/006436

§ 371 Date: Sep. 28, 2012

(30) Foreign Application Priority Data
Mar. 29, 2010 (JP) 2010-074652

(51) Int. Cl. G09G 3/36; G06F 15/00; G06F 3/038

(52) U.S. Cl. 345/501; 345/207; 345/204; 345/102

(57) ABSTRACT

A display device includes a display panel in which a plurality of pixels are arranged in a display region; a plurality of photosensors each configured to receive external light irradiating the display region of the display panel; and a graphic display controller in which a reference value is preset for light reception information obtained by the photosensors and which is configured to display, when one or more of values for the light reception information exceeding the reference value is obtained by the photosensors, a graphic image indicating predetermined information in the display region based on the light reception information.

### TECHNICAL FIELD

The present invention relates to a display device, a liquid crystal module, and an image display system.

### BACKGROUND ART

In recent years, a demand for thin display devices such as liquid crystal display devices (LCDs), organic electro-luminescence displays (OEL displays), and plasma display panels (PDPs) has been significantly increased. Since each of the foregoing display devices is thin, there is an advantage that the display device can be placed in various places.

The LCD includes a liquid crystal panel formed by bonding a pair of substrates facing each other, and a backlight unit arranged so as to face a rear surface of the liquid crystal panel. The liquid crystal panel includes a liquid crystal layer formed between the substrates.

When a display region of the LCD is irradiated with external light, the external light is reflected by a surface of the liquid crystal panel, and therefore contrast of a display image is degraded. The “external light” means light emitted from a device other than a display device (including an LCD). Thus, the “external light” includes light emitted from room lighting to irradiate a display device, and light emitted from outside to irradiate a display device.

Patent Document 1 discloses the following LCD. Based on light reception information obtained by each photosensor, the LCD increases, when it is bright around the LCD, the luminance of a backlight unit, and controls, when it is dark around the LCD, dimming of the backlight unit such that the luminance of the backlight unit is decreased. In the LCD, the dimming control is not performed when the luminance of the periphery of the LCD is partially changed, and is performed only when the luminance of the periphery of the LCD is uniformly changed.

Patent Document 2 discloses the following. A plurality of photosensors are provided in a display region of a liquid crystal panel. Based on the intensity of outside light detected for each predetermined region by each of the light sensors, an image signal(s) is corrected to compensate for degradation of contrast of a display image due to outside light.

Patent Document 3 discloses the following. When the brightness of a place where an image is viewed for a predetermined period of time is detected, if the brightness of the place is equal to or less than a predetermined brightness, subtitles are displayed, and audio is muted.

### CITATION LIST

### Patent Document

PATENT DOCUMENT 1: Japanese Patent Publication No. 2005-121997
PATENT DOCUMENT 2: Japanese Patent Publication No. 2008-233379
PATENT DOCUMENT 3: Japanese Patent Publication No. 2007-336313

### SUMMARY OF THE INVENTION

### Technical Problem

FIG. 38 is an explanatory view illustrating the state in which a display region 501 of a display device 500 is irradiated with light of the sun 502. In the display region 501, a bright region 504 irradiated with sun light 503 and a dark region 505 are formed.

However, referring to FIG. 38, if the external light is strong light such as the sun light 503, there is a disadvantage that, even if the luminance of a backlight unit is increased, a viewer remains difficult to view a display image in the bright region 504 of the display region 501. In such a case, another disadvantage is that effective information cannot be displayed in the light region 504.

The present invention has been made in view of the foregoing, and it is an objective of the present invention to reduce stress on a viewer when a display screen is irradiated with strong external light.

### Solution to the Problem

In order to accomplish the foregoing objective, a display device of the present invention includes a display panel in which a plurality of pixels are arranged in a display region; a plurality of photosensors each configured to receive external light irradiating the display region of the display panel; and a graphic display controller in which a reference value is preset for light reception information obtained by the photosensors and which is configured to display, when one or more of values for the light reception information exceeding the reference value is obtained by the photosensors, a graphic image indicating predetermined information in the display region based on the light reception information.

Features

According to the present invention, when the display region of the display panel is irradiated with external light, light reception information of the external light is obtained by the plurality of photosensors arranged in the display region. When the display region is irradiated with strong external light having strength exceeding the reference value preset for the obtained light reception information, the graphic display controller displays a graphic image indicating predetermined information based on the light reception information of the external light.

In the present specification, the graphic image includes, e.g., display images appealing to vision, such as subtitles, moving images of character strings, still images, characters, and figures.

It is difficult for a viewer to view a display image in a region of the display region irradiated with strong external light. However, in the present invention, a graphic image is displayed in the foregoing state, and therefore the viewer can perceive information indicated by the graphic image. Thus, stress on the viewer due to viewer's difficulty of viewing an image is reduced.

### Advantages of the Invention

According to the present invention, when the display region is irradiated with strong external light having the strength exceeding the reference value, the graphic display controller displays a graphic image, and therefore a viewer can perceive information indicated by the graphic image. Thus, stress on the viewer due to viewer's difficulty of viewing an image can be reduced.

### BRIEF DESCRIPTION OF THE DRAWINGS

FIG. 1 is a longitudinal sectional view of an LCD of a first embodiment of the present invention.

FIG. 2 is a block diagram schematically illustrating a structure of the LCD.

FIG. 3 is an enlarged cross-sectional view illustrating a structure of a liquid crystal panel.

FIG. 4 is a block diagram schematically illustrating a wiring configuration and a controller in the LCD.

FIG. 5 is a circuit diagram illustrating a configuration of a pixel.

FIG. 6 is another circuit diagram illustrating the configuration of the pixel.

FIG. 7 is an enlarged plan view schematically illustrating a backlight unit.

FIG. 8 is a block diagram illustrating a configuration of the controller.

FIG. 9 is a flow chart illustrating a method for controlling the LCD.

FIG. 10 is a plan view illustrating the LCD irradiated with external light.

FIG. 11 is another plan view illustrating the LCD irradiated with external light.

FIG. 12 is still another plan view illustrating the LCD irradiated with external light.

FIG. 13 is still another plan view illustrating the LCD irradiated with external light.

FIG. 14 is still another plan view illustrating the LCD irradiated with external light.

FIG. 15 is still another plan view illustrating the LCD irradiated with external light.

FIG. 16 is an LCD block diagram schematically illustrating a variation of arrangement of photosensors.

FIG. 17 is an LCD block diagram schematically illustrating another variation of the arrangement of the photosensors.

FIG. 18 is an LCD block diagram schematically illustrating still another variation of the arrangement of the photosensors.

FIG. 19 is an LCD block diagram schematically illustrating still another variation of the arrangement of the photosensors.

FIG. 20 is an LCD block diagram schematically illustrating still another variation of the arrangement of the photosensors.

FIG. 21 is an LCD block diagram schematically illustrating still another variation of the arrangement of the photosensors.

FIG. 22 is an LCD block diagram schematically illustrating still another variation of the arrangement of the photosensors.

FIG. 23 is an LCD block diagram schematically illustrating still another variation of the arrangement of the photosensors.

FIG. 24 is an enlarged cross-sectional view illustrating the structure of the liquid crystal panel.

FIG. 25 is an enlarged cross-sectional view illustrating another structure of the liquid crystal panel.

FIG. 26 is an enlarged cross-sectional view illustrating still another structure of the liquid crystal panel.

FIG. 27 is an enlarged plan view schematically illustrating the backlight unit.

FIG. 28 is a longitudinal sectional view of one example of an LCD of a second embodiment of the present invention.

FIG. 29 is a block diagram schematically illustrating a wiring structure and a controller in an LCD of a third variation.

FIG. 30 is a timing chart illustrating intermittent driving of a backlight unit.

FIG. 31 is a block diagram schematically illustrating a wiring structure and a controller in an LCD of a fourth embodiment.

FIG. 32 is an enlarged plan view schematically illustrating a backlight unit of a fifth embodiment.

FIG. 33 is a diagram of a circuit for using electromotive force generated by photosensors in a sixth embodiment.

FIG. 34 is a block diagram schematically illustrating an image display system, e.g., a digital signage system, of a seventh embodiment.

FIG. 35 is an exploded perspective view illustrating a schematic configuration of an LCD.

FIG. 36 is a block diagram schematically illustrating a liquid crystal module.

FIG. 37 is a block diagram schematically illustrating a backlight unit.

FIG. 38 is an explanatory view illustrating the state in which a display region of a display device is irradiated with sun light.

### DESCRIPTION OF EMBODIMENTS

Embodiments of the present invention will be described below in detail with reference to drawings. Note that the present invention is not limited to the embodiments described below.

### First Embodiment of the Invention

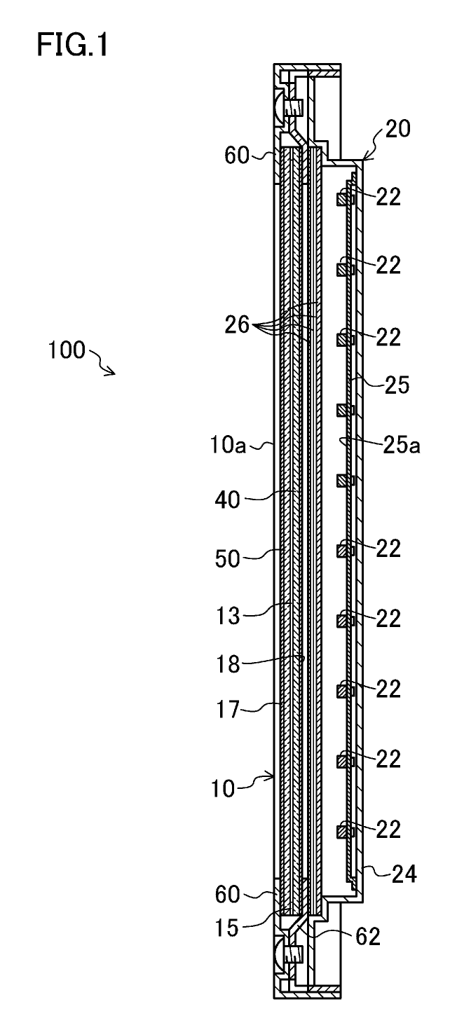

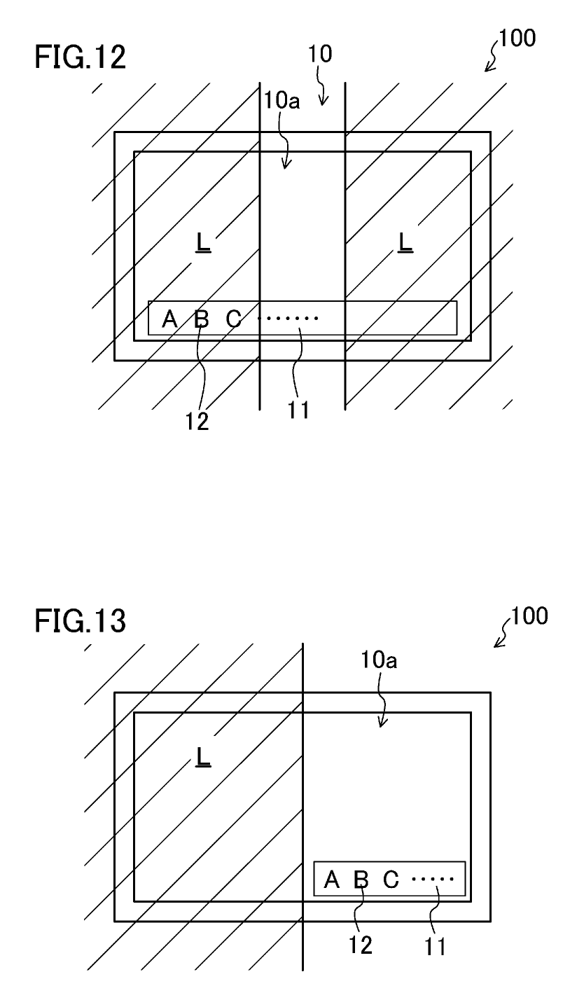

FIGS. 1-15 illustrate a first embodiment of the present invention.

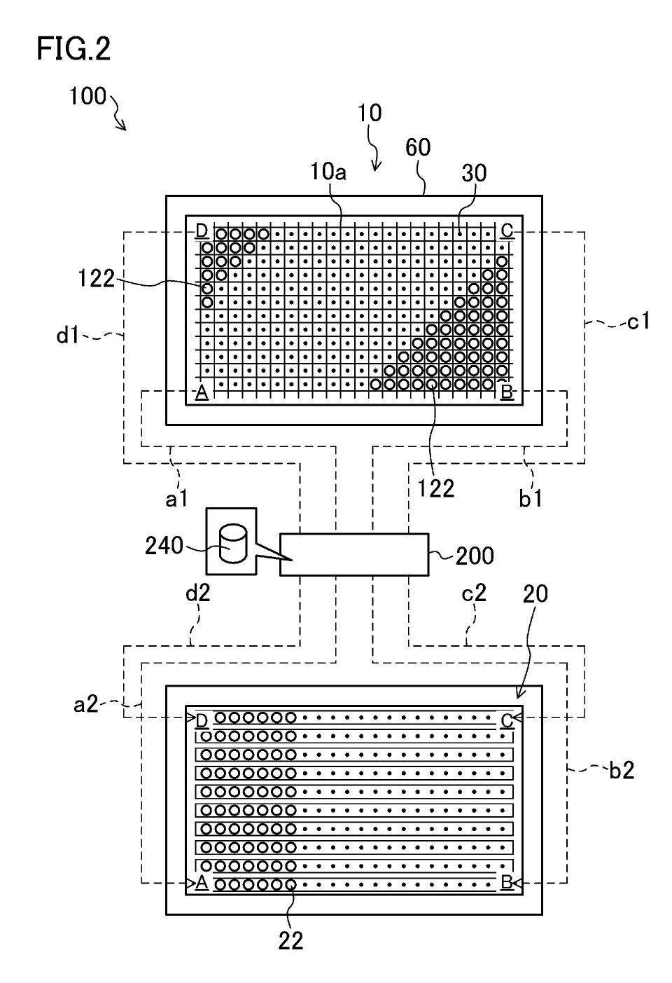

FIG. 1 is a longitudinal sectional view of an LCD 100 of the first embodiment of the present invention. FIG. 2 is a block diagram schematically illustrating a structure of the LCD 100. For the sake of illustration, a liquid crystal panel 10 and a backlight unit 20 are illustrated in an exploded state in FIG. 2.

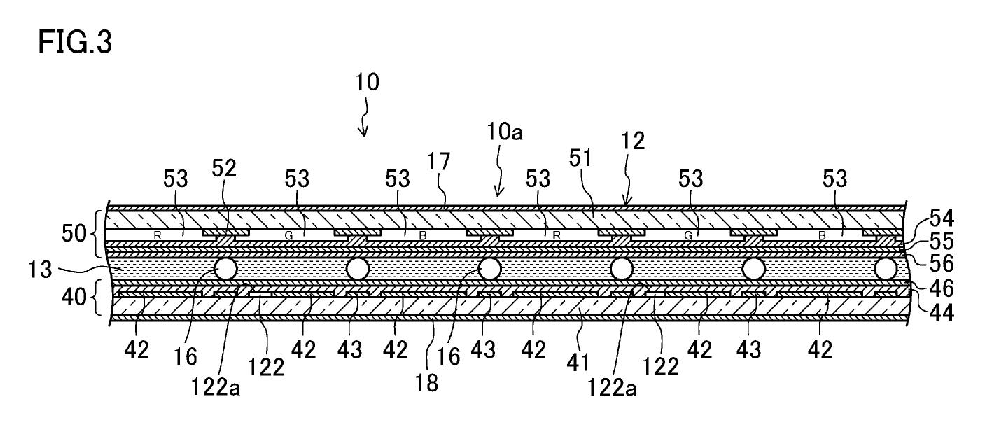

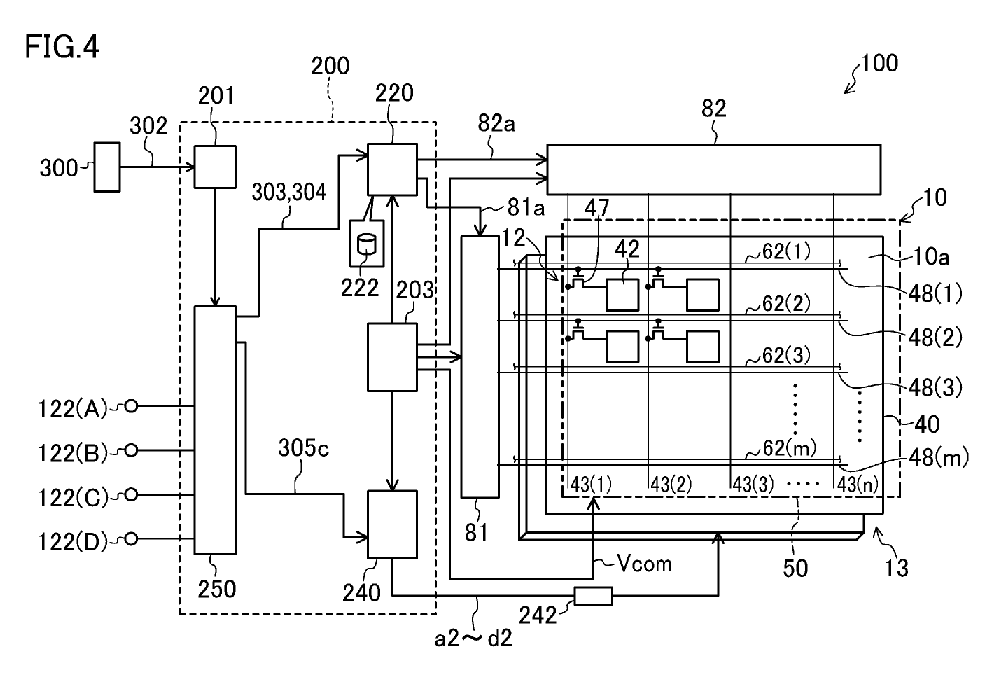

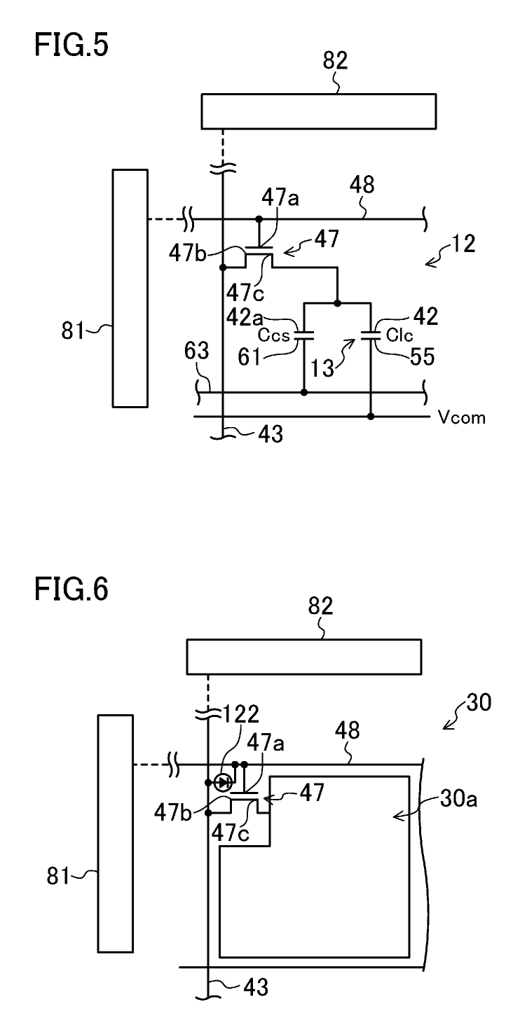

FIG. 3 is an enlarged cross-sectional view illustrating a structure of the liquid crystal panel 10. FIG. 4 is a diagram schematically illustrating a wiring configuration and a controller 200 in the LCD 100. FIGS. 5 and 6 are circuit diagrams illustrating a configuration of a pixel 30.

The LCD 100 is used as, e.g., a digital signage such as an information display placed outside. Referring to FIGS. 1 and 4, the LCD 100 includes the liquid crystal panel 10, the backlight unit 20 arranged so as to face the liquid crystal panel 10, photosensors 122, and the controller 200. Each configuration will be described below.

In the present specification, a side of the liquid crystal panel 10 opposite to the backlight unit 20 is referred to as a “front surface side (or a front side),” and a side of the backlight unit 20 opposite to the liquid crystal panel 10 is referred to as a “rear surface side (or a rear side).”

<<Structure of Liquid Crystal Panel 10>>

Referring to FIGS. 1 and 2, the liquid crystal panel 10 includes a display region 10a where an image is displayed, and a frame-shaped non-display region provided around the display region 10a. In the display region 10a, a plurality of pixels 30 are arranged in a matrix. In the present embodiment, the liquid crystal panel 10 is in a substantially rectangular shape, and the display region 10a is also in a substantially rectangular shape.

The liquid crystal panel 10 further includes a liquid crystal layer 13 and a pair of translucent substrates 40, 50 bonded together with the liquid crystal layer 13 being interposed therebetween. The translucent substrates 40, 50 are a color filter substrate (CF substrate) 50 and an array substrate (TFT substrate) 40 arranged on the rear side of the CF substrate 50 (i.e., on a side closer to the backlight unit 20).

Referring to FIG. 1, a sealing member 15 is provided between the array substrate 40 and the CF substrate 50 so as to surround the rectangular display region 10a (i.e., an outer periphery of the display region 10a). The liquid crystal layer 13 is enclosed between the array substrate 40 and the CF substrate 50 by the sealing member 15. An alignment direction of liquid crystal molecules contained in the liquid crystal layer 13 is controlled by an electric field generated between the array substrate 40 and the CF substrate 50. Optical characteristics of the liquid crystal panel 10 are changed depending on the alignment direction of the liquid crystal molecules.

Referring to FIG. 3, spacers 16 are interposed between the array substrate 40 and the CF substrate 50. A distance between the array substrate 40 and the CF substrate 50 is maintained at a predetermined distance by the spacers 16.

(Array Substrate 40)

Referring to FIGS. 3-6, the array substrate 40 includes, e.g., pixel electrodes 42, data signal lines 43, scanning signal lines 48, auxiliary capacitor lines 63, a polarizing layer 44, an alignment film 46, and thin film transistors (TFTs) 47. Each of the foregoing is formed on the front side of a glass substrate 41 (i.e., on a side closer to the liquid crystal layer 13).

That is, a plurality of scanning signal lines 48(1)-48(m) extending parallel to each other and a plurality of data signal lines 43(1)-43(n) extending perpendicular to the scanning signal lines 48(1)-48(m) are, referring to FIG. 4, formed on the glass substrate 41. The characters in parentheses are for distinguishing the scanning signal lines 48 from each other and for distinguishing the data signal lines 43 from each other.

The scanning signal lines 48(1)-48(m) and the data signal lines 43(1)-43(n) are arranged at predetermined intervals, and are formed in a grid pattern. The pixel 30 is formed in a rectangular region surrounded by adjacent ones of the scanning signal lines 48(1)-48(m) and adjacent ones of the data signal lines 43(1)-43(n).

In each of the pixels 30, the pixel electrode 42 and the TFT 47 connected to the pixel electrode 42 are formed. The pixel electrode 42 is made of indium tin oxide (ITO) which is a transparent conductive material. The TFT 47 is connected to the scanning signal line 48 and the data signal line 43. Voltage corresponding to an image is supplied to the pixel electrode 42 through the data signal line 43 and the TFT 47 at predetermined timing.

A plurality of auxiliary capacitor lines 63(1)-63(m) each arranged along a corresponding one of the scanning signal lines 48(1)-48(m) are formed on the glass substrate 41. The characters in parentheses are for distinguishing the auxiliary capacitor lines 63 from each other.

Referring to FIG. 5, in each of the pixels 30, the TFT 47, a liquid crystal capacitor Clc, and an auxiliary capacitor Ccs are formed. A gate electrode 47a of the TFT 47 is connected to the scanning signal line 48. A source electrode 47b of the TFT 47 is connected to the data signal line 43.

The auxiliary capacitor Ccs includes a first electrode 61 and a second electrode 42a. The first electrode 61 is connected to the auxiliary capacitor line 63, and the second electrode 42a is connected to a drain electrode 47c of the TFT 47. The auxiliary capacitor Ccs receives a control signal(s) from the auxiliary capacitor line 63 to maintain voltage (liquid crystal capacitor Clc) applied to the pixel 30. The liquid crystal capacitor Clc includes the pixel electrode 42 and a later-described common electrode 55 formed on the CF substrate 50. The pixel electrode 42 is connected to the drain electrode 47c of the TFT 47.

The polarizing layer 44 is made of an insulating material, and covers, e.g., the TFTs 47, the pixel electrodes 42, the data signal lines 43, the scanning signal lines 48, and the auxiliary capacitor lines 63. The alignment film 46 made of, e.g., polyimide is formed on the polarizing layer 44.

(CF Substrate 50)

Referring to FIG. 3, the CF substrate 50 includes, on a side of a glass substrate 51 closer to the liquid crystal layer 13, a black matrix 52, colored layers 53, a polarizing layer 54, the common electrode 55, and an alignment film (horizontal alignment film) 56.

The black matrix 52 is made of a material (e.g., metal such as chromium (Cr)) through which light does not pass, and is provided between adjacent ones of the colored layers 53 so as to separate the pixels 30 from each other. The colored layer 53 is a filter for adjusting color tones. The colored layer 53 absorbs light having wavelengths corresponding to colors other than the color of the colored layer 53 itself, thereby adjusting the color tones of transmitted light. In the present embodiment, the colored layers 53 of three colors, i.e., red (R), green (G), and blue (B), are arranged in this order for each of the pixels 30.

Referring to FIG. 3, the polarizing layer 54 is formed so as to cover the black matrix 52 and the colored layers 53. In addition, the common electrode 55 made of a transparent conductive film such as ITO is formed so as to cover the polarizing layer 54. Further, the alignment film 56 is formed so as to cover the common electrode 55. The alignment film 56 faces the alignment film 46 of the array substrate 40. The alignment films 46, 56 of the substrates 40, 50 define the alignment direction of the liquid crystal molecules in the state in which voltage is not applied. In the present embodiment, alignment directions of the alignment films 56, 46 are 90 degrees apart.

Referring to FIGS. 1 and 3, polarizers 17, 18 are bonded respectively to surfaces of the glass substrates 51, 41 on a side opposite to the liquid crystal layer 13. If the LCD 100 is a so-called “normally white type LCD,” the polarizers 17, 18 are arranged such that polarizing axes of the polarizers 17, 18 are perpendicular to each other. On the other hand, if the LCD 100 is a normally black type LCD, the polarizing axes of the polarizers 17, 18 are parallel to each other.

Referring to FIG. 1, the liquid crystal panel 10 is supported so as to be sandwiched between a bezel 60 attached on the front surface side (front side) and a frame 62 attached on the rear surface side (rear side). Referring to FIG. 2, the bezel 60 is a frame provided along the outer periphery of the display region 10a of the liquid crystal panel 10, and part of the bezel 60 corresponding to the display region 10a is open.

<<Structure of Backlight Unit 20>>

The backlight unit 20 is arranged so as to face the rear side of the liquid crystal panel 10. Referring to FIG. 1, the backlight unit 20 includes a backlight unit chassis 24 which is a substantially rectangular housing. An opening is formed on the front side of the backlight unit chassis 24.

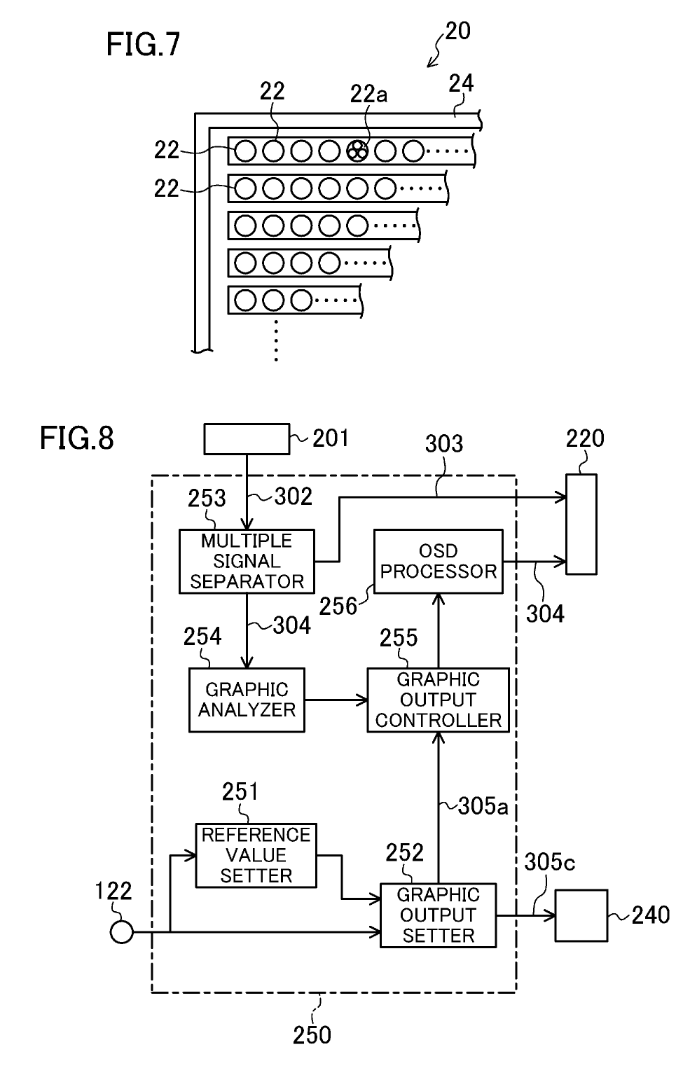

FIG. 7 is an enlarged plan view schematically illustrating the backlight unit 20. Referring to FIG. 7, the backlight unit 20 includes a plurality of irradiators 22 each configured to irradiate a rear surface of the liquid crystal panel 10 with light. In the present embodiment, a reflector 25 is, referring to FIG. 1, attached to an inner part of the backlight unit chassis 24. The irradiators 22 are arranged on a surface (reflection surface) 25a of the reflector 25 facing the liquid crystal panel 10. Referring to FIG. 7, each of the irradiators 22 includes a plurality of point light sources 22a.

The LCD 100 controls the irradiators 22 each including the point light sources 22a, thereby partially adjusting the luminance and chromaticity of illumination light emitted from the backlight unit 20. In the present embodiment, the irradiators 22 are, referring to FIG. 7, arranged in a grid pattern. Note that the arrangement of the irradiators 22 is not limited to the grid pattern. For example, the irradiators 22 may be in such an arrangement that the positions of the irradiators 22 in a row are displaced from the positions of the irradiators 22 in another row (i.e., the arrangement of the irradiators 22 in a staggered pattern or a zigzag pattern).

The point light source 22a is, e.g., a light emitting diode (LED). That is, a plurality of LEDs 22a form a single irradiator 22. There is a case where illumination light emitted from the backlight unit 20 is preferably white light. In the present embodiment, the LEDs 22a of three colors, i.e., red (R), green (G), and blue (B) form the irradiator 22. Light from the LED 22a of R, light from the LED 22a of G, and light from the LED 22a of B are mixed together to generate white illumination light. Note that a method for generating white illumination light is not limited to the foregoing method. For example, white LEDs configured to emit white light may form the irradiator 22.

Power to be applied to each of the LEDs 22a of the irradiator 22 is controlled, and therefore the brightness of illumination light is adjusted. That is, greater power applied to the irradiator 22 results in brighter illumination light (higher luminance), and smaller power applied to the irradiator 22 results in darker illumination light (lower luminance). Power to be applied to the irradiator 22 may be controlled by, e.g., pulse width modulation (PWM).

A plurality of optical sheets 26 are arranged between the liquid crystal panel 10 and the backlight unit 20. The optical sheets 26 are sandwiched between a front surface of the backlight unit chassis 24 and a rear surface of the frame 62 attached to the liquid crystal panel 10, and cover the opening of the backlight unit chassis 24. The optical sheet 26 is, e.g., a diffuser, a diffuser sheet, a lens sheet, and a luminance enhancement sheet.

<<Configuration of Photosensor 122>>

The photosensor 122 is configured to receive external light irradiating the display region 10a of the liquid crystal panel 10. For example, the photosensors 122 are, referring to FIG. 2, dispersively arranged in the display region 10a of the liquid crystal panel 10. Thus, in various parts of the display region 10a, the photosensors 122 can obtain light reception information of external light irradiating the display region 10a.

Referring to FIGS. 2 and 3, the photosensor 122 is, as viewed in the plane, arranged in a region of the liquid crystal panel 10 where each of the pixels 30 is formed. Thus, light reception information a1-d1 of external light irradiating the display region 10a can be obtained for each of the pixels 30. Note that the arrangement of the photosensors 122 is not limited to the foregoing arrangement, and the photosensor 122 may be provided for each pixel group (e.g., a pixel group of 8 pixels×8 pixels, and a pixel group of 10 pixels×10 pixels) including a plurality of pixels. In such a case, the light reception information a1-d1 can be obtained for each pixel group. In addition, the pixel groups can be set as necessary.

Each of the pixels 30 includes sub-pixels of red (R), green (G), and blue (B). The photosensor 122 is provided at one of the sub-pixels of red (R), green (G), and blue (B). In the present embodiment, the photosensor 122 is provided at the sub-pixel of green (G).

As the photosensor 122, a sensor configured to generate electrical information depending on received light can be used. For example, a sensor configured to generate photovoltaic power (electromotive force) depending on external light received by a light receptor 122a can be used as the photosensor 122. As such an photosensor 122, e.g., a photodiode and a phototransistor can be used. In addition, a photoresistor having an electric resistance changing depending on the intensity of received light can be used as the photosensor 122.

Specific contents of the “light reception information” vary depending on the type of the sensor, a circuit configuration, etc. In the present embodiment, a photodiode is used as the photosensor 122. In order to receive external light, the photosensor 122 may be, referring to FIG. 3, arranged such that the light receptor 122a faces the front relative to the liquid crystal panel 10.

Referring to FIG. 4, the photosensors 122 are connected to the controller 200. Photovoltaic power generated in the photosensors 122 is sent to the controller 200 as the “light reception information a1-d1.”

<<Configuration of Controller 200>>

Referring to FIG. 4, the controller 200 is connected to the liquid crystal panel 10 and the backlight unit 20. In addition, signals from the photosensors 122 and an external system 300 which will be described later are input to the controller 200.

The external system 300 is, e.g., a personal computer (PC) operated by an administrator of the LCD 100, and is configured to supply a digital signal 302 which is a multiple signal of an image signal and a graphic signal for displaying an image on the LCD 100, to the controller 200.

The controller 200 is an electronic processing device. Referring to FIG. 4, the controller 200 includes a liquid crystal panel controller 220, a backlight unit controller 240, a signal inputter 201, a power source 203, and a graphic display controller 250 connected to the foregoing sections of the controller 200. The controller 200 is configured to control the liquid crystal panel 10 and the backlight unit 20 based on signals input from the photosensors 122 and the external system 300.

(Signal Inputter 201)

The digital signal 302 is input from the external system 300 to the signal inputter 201. The signal inputter 201 outputs the input digital signal 302 to the graphic display controller 250.

(Graphic Display Controller 250)

In the graphic display controller 250, a reference value is preset for the light reception information a1-d1 obtained by the photosensors 122. If one or more of values for the light reception information a1-d1 exceeding the reference value is obtained by the photosensors 122, the graphic display controller 250 displays, based on the light reception information a1-d1, a graphic image indicating predetermined information in the display region 10a. When the display region 10a is irradiated with strong external light having strength exceeding the preset reference value, the LCD 100 displays the graphic image indicating predetermined information. Thus, stress on a viewer when the viewer perceives an image can be reduced.

Referring to FIG. 8, the graphic display controller 250 includes a reference value setter 251, a graphic output setter 252, a multiple signal separator 253, a graphic analyzer 254, a graphic output controller 255, and an on-screen display (OSD) processor 256.

The reference value setter 251 has a function to set a reference value for the light reception information a1-d1 input from the photosensors 122 and output the reference value to the graphic output setter 252. The graphic output setter 252 has a function to set a graphic display area in the display region 10a based on the reference value and values for the light reception information a1-d1 input from the photosensors 122. In addition, the graphic output setter 252 is configured to output a control signal 305a relating to the set graphic display area to the graphic output controller 255, and output a control signal 305c relating to the set graphic display area to the backlight unit controller 240.

The multiple signal separator 253 has a function to separate the digital signal 302 received by the signal inputter 201 into an image signal 303 and a graphic signal 304. The multiple signal separator 253 is configured to output the separated image signal 303 to the liquid crystal panel controller 220 and output the separated graphic signal 304 to the graphic analyzer 254. The graphic analyzer 254 is configured to analyze the graphic signal 304 separated by the multiple signal separator 253 and output the analyzed graphic signal 304 to the graphic output controller 255.

The graphic output controller 255 has a control function to change the dimensions of a graphic image depending on the graphic display area set by the graphic output setter 252. In addition, the graphic output controller 255 is configured to output the controlled graphic signal 304 to the OSD processor 256. The OSD processor 256 is configured to output the OSD-processed graphic signal 304 to the liquid crystal panel controller 220.

(Liquid Crystal Panel Controller 220)

The liquid crystal panel controller 220 is connected to the power source 203.

The liquid crystal panel controller 220 is configured to control the liquid crystal panel 10 based on the image signal 303 and the graphic signal 304 supplied from the graphic display controller 250 and adjust light permeability of the liquid crystal panel 10.

More specifically, the scanning signal lines 48(1)-48(m) of the liquid crystal panel 10 are connected to a gate driver 81, and the data signal lines 43(1)-43(n) of the liquid crystal panel 10 are connected to a source driver 82. The gate driver 81 and the source driver 82 are connected to the liquid crystal panel controller 220.

The liquid crystal panel controller 220 includes a timing controller 222. The liquid crystal panel controller 220 is configured to supply a liquid crystal panel control signal 81a generated based on the image signal 303 and the graphic signal 304 to the gate driver 81, and supply a liquid crystal panel control signal 82a generated based on the image signal 303 and the graphic signal 304 to the source driver 82. At this point, the timing controller 222 adjusts timing at which the liquid crystal panel control signals 81a, 82a are transmitted respectively to the gate driver 81 and the source driver 82.

Then, an image corresponding to the image signal 303 is displayed in the display region 10a, and a graphic image is OSD-displayed in the predetermined graphic display area of the display region 10a.

(Power Source 203)

The power source 203 is configured to supply operation power to each of the components (e.g., the liquid crystal panel 10 and the backlight unit 20) forming the LCD 100. Referring to FIG. 4, the power source 203 is configured to supply, in addition to the operation power, common electrode voltage (Vcom) to the common electrode 55 (see FIG. 3) of the CF substrate 50. The common electrode voltage (Vcom) supplied to the common electrode 55 is used as voltage to be applied to the liquid crystal layer 13 sandwiched between the array substrate 40 and the CF substrate 50.

(Backlight Unit Controller 240)

The backlight unit controller 240 has a function to control, based on the light reception information a1-d1 obtained by the photosensors 122, the irradiators 22 in each of a plurality of divided areas A-D of the display region 10a and adjust the brightness (luminance) of illumination light.

That is, the backlight unit controller 240 generates backlight unit control signals a2-d2 based on the control signal 305c supplied from the graphic output setter 252. Power controlled based on the backlight unit control signals a2-d2 is applied to the irradiators 22 of the backlight unit 20. This adjusts illumination light emitted from the backlight unit 20. As described above, the controller 200 controls the liquid crystal panel 10 and the backlight unit 20, thereby displaying a desired image in the display region 10a.

The backlight unit controller 240 controls power to be applied to the LEDs (point light sources) 22a forming the irradiators 22, thereby adjusting the brightness and color tones of illumination light emitted from the backlight unit 20.

Method for Controlling LCD 100

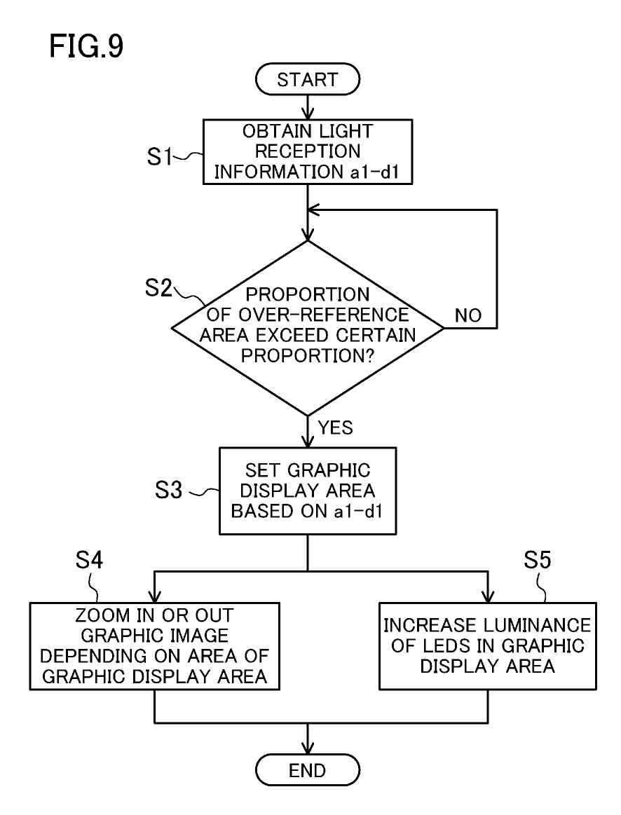

Next, a method for controlling the LCD 100 will be described with reference to FIG. 9 illustrating a control flow.

The LCD 100 is placed outside as the digital signage. The LCD 100 is configured to display, based on a digital signal 302 input from the external system 300, a predetermined image and a graphic image under predetermined conditions. The digital signal 302 is obtained by, e.g., a digital signage system or digital broadcasting.

First, when a digital signal 302 is input to the signal inputter 201 of the controller 200, the signal inputter 201 outputs the input digital signal 302 to the multiple signal separator 253 of the graphic display controller 250.

The multiple signal separator 253 separates the digital signal 302 received by the signal inputter 201 into an image signal 303 and a graphic signal 304. The image signal 303 separated by the multiple signal separator 253 is output to the liquid crystal panel controller 220. Then, the liquid crystal panel controller 220 supplies liquid crystal panel control signals 81a, 82a generated based on the image signal 303 respectively to the gate driver 81 and the source driver 82, and displays an image corresponding to the image signal 303 in the display region 10a. Meanwhile, the graphic signal 304 separated by the multiple signal separator 253 is input to the graphic analyzer 254. The graphic analyzer 254 analyzes the graphic signal 304 and outputs the analyzed graphic signal 304 to the graphic output controller 255.

At step S1 in FIG. 9, light reception information a1-d1 of light entering the display region 10a is obtained by the photosensors 122 (first step). Each of the photosensors 122 receives, as external light, light surrounding the LCD 100 and sun light directly irradiating the display region 10a.

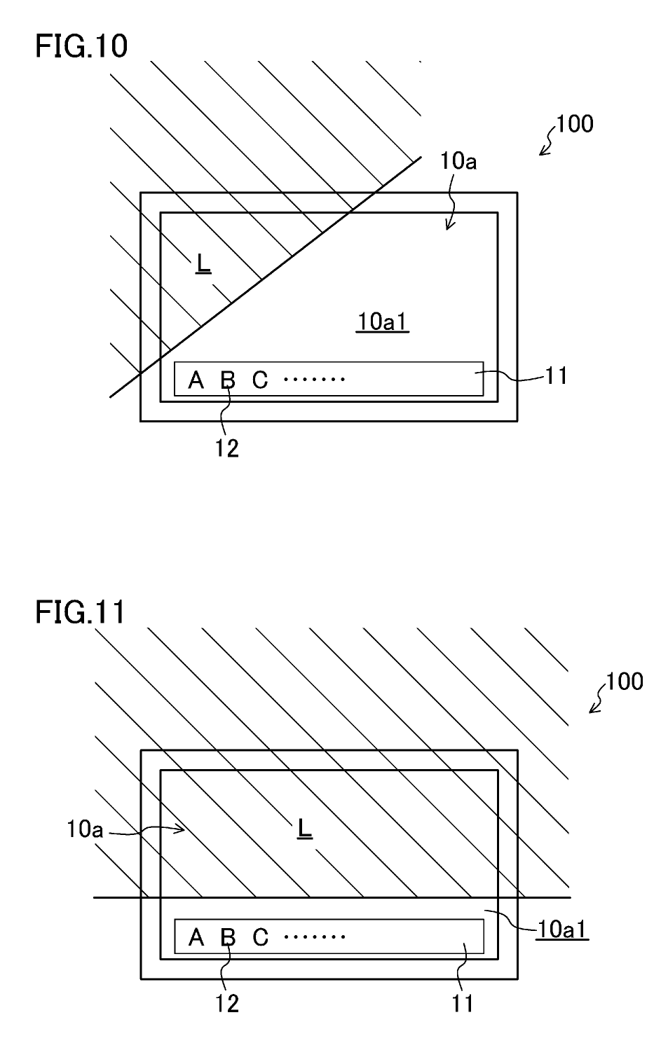

FIGS. 10-15 are plan views illustrating the LCD 100 directly irradiated with sun light L which is the external light. When the display region 10a is directly irradiated with the sun light L having an intensity greater than that of surrounding light, it is difficult for the viewer to view an image in a region of the display region 10a irradiated with the sun light L.

The light reception information a1-d1 obtained by the photosensors 122 is output to the reference value setter 251 and the graphic output setter 252. The reference value setter 251 sets a reference value based on the light reception information a1-d1, and outputs the reference value to the graphic output setter 252. For example, the reference value can be set to be greater, by a predetermined value, than a value for the light reception information a1-d1 relating to the display region 10a irradiated with the surrounding light.

Next, at step S2 in FIG. 9, the graphic output setter 252 determines whether or not the proportion of the area of part of the display region 10a corresponding to one or more of values for the light reception information a1-d1 exceeding the reference value to the entire area of the display region 10a exceeds a certain proportion. Then, at step S3 in FIG. 9, the following is performed if the proportion of the area of part of the display region 10a exceeds the certain proportion. Referring to FIGS. 10 and 11, in a region (i.e., a relatively-dark region) of the display region 10a other than part of the display region 10a corresponding to one or more of values for the light reception information a1-d1 exceeding the reference value, the graphic output setter 252 sets, based on the light reception information a1-d1, a graphic display area 11 where a graphic image 12 such as subtitles is displayed.

The graphic image 12 includes, in addition to subtitles, display images appealing to vision, such as moving images of character strings, still images, characters, and figures. For example, the graphic image 12 may be a combination of a still image and subtitles. The graphic image 12 indicates, e.g., information relating to the contents of an image displayed in the display region 10a. Thus, the information relating to the display image can be provided to the viewer with the graphic image 12 such as subtitles.

At step S4 in FIG. 9, the graphic output controller 255 changes the dimensions of the graphic image 12 depending on the graphic display area 11. For example, if the left half of the display region 10a is, referring to FIG. 13, irradiated with the sun light L, the graphic display area 11 is set in a relatively-dark region on the right side, and the graphic image 12 is displayed across the right-left width of the graphic display area 11 (second step). This allows the viewer to easily view the entirety of the graphic image 12.

At step S5 in FIG. 9, the backlight unit controller 240 controls, based on a control signal 305c received from the graphic output setter 252, the irradiators 22 of the backlight unit 20 in one or more of the areas A-D including the graphic display area 11, thereby increasing the luminance of the irradiators 22. Thus, the graphic image 12 can be more easily viewed.

Note that the graphic output setter 252 is capable of displaying the graphic image 12 in a preset region (e.g., a region along a lower side of the display region 10a referring to FIGS. 10-12) of the display region. Thus, a display image overlaps with a graphic image as little as possible in a center part of the display region 10a, and degradation of image visibility can be reduced.

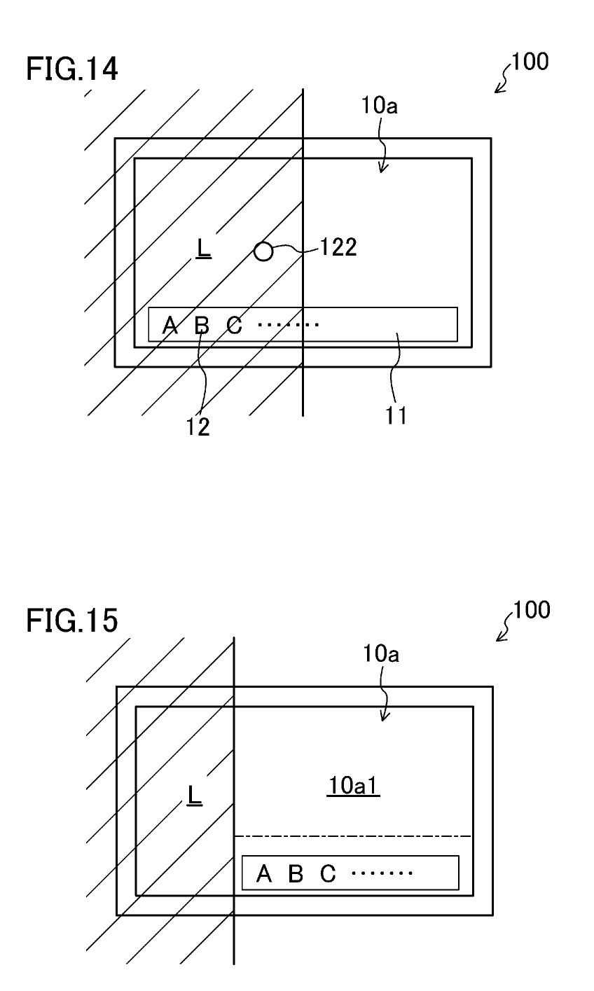

Referring to FIG. 14, a display of the graphic image 12 may be controlled based on light reception information obtained by the photosensor 122 arranged in the center part of the display region 10a.

In such a case, the reference value setter 251 of the graphic display controller 250 sets a reference value based on the light reception information obtained by the photosensor 122 arranged in the center part of the display region 10a, and outputs the reference value to the graphic output setter 252. If one or more of values for the light reception information exceeds the reference value, the graphic output setter 252 sets the graphic display area 11 based on the light reception information. As in the foregoing control, the liquid crystal panel controller 220 OSD-displays the graphic image 12 in the graphic display area 11. In such a manner, stress on the viewer due to viewer's difficulty of viewing an image can be reduced by a small number of the photosensors 122 arranged in the center part of the display region 10a.

Referring to FIG. 15, if the proportion of the area of part of the display region 10a corresponding to one or more of values for the light reception information exceeding the reference value to the entire area of the display region 10a exceeds the certain proportion, a region (i.e., a region other than part of the display region 10a corresponding to one or more of values for the light reception a1-d1 exceeding the reference value) which is not irradiated with the sun light L is divided into, e.g., two regions. An image display area 10a1 where an image is displayed may be set in one of the divided regions, and the graphic display area 11 may be set in the other divided region.

In such a case, the graphic output setter 252 detects, by image analysis, coordinate information of the graphic display area 11 arranged in the region which is not irradiated with the sun light L, and sets the image display area 10a1 in part (i.e., an unassigned region) of the region which is not irradiated with the sun light L other than the graphic display area 11. The graphic image 12 to be displayed in the graphic display area 11 in the state in which the graphic image 12 is zoomed in or out and the display image to be displayed in the image display area 10a1 are synthesized by the graphic output controller 255, and then are displayed in the display region 10a.

As a method for the image analysis, e.g., the following method can be employed. An image having a predetermined color(s) or a predetermined pattern(s) is formed in a background region of the display region 10a other than the graphic display area 11. The predetermined color(s) or the predetermined pattern(s) is detected, and therefore coordinates indicating the range of the graphic display area 11 can be obtained.

In the foregoing manner, since an overlap between the display image and the graphic image is reduced as much as possible, the degradation of the image visibility can be reduced. The luminance of the irradiators 22 in the image display area 10a1 and the luminance of the irradiators 22 in the graphic display area 11 are independently controlled, and the image in the image display area 10a1 and the graphic image 12 in the graphic display area 11 can be displayed with suitable brightness. Thus, the viewer's visibility can be further enhanced.

Note that the display region 10a is not necessarily divided into two regions, and may be divided into three or more regions. In such a case, the graphic display area 11 or the image display area 10a1 may be set in each of the divided regions.

When the proportion of the area of part of the display region 10a corresponding to one or more of values for the light reception information exceeding the reference value to the entire area of the display region 10a exceeds the certain proportion, only the graphic image 12 such as subtitles and still images may be displayed in a region which is not irradiated with the sun light L.

The backlight unit controller 240 may obtain a difference in a value for the light reception information a1-d1 among some of the photosensors 122 preset as sensors by which the reference value is obtained and the other photosensors 122, and control the irradiators 22 based on the difference in the value for the light reception information a1-d1.

In such a case, a setting for the photosensors 122 by which the reference value is obtained may be saved into the backlight unit controller 240 in advance. A setting for the way to control the irradiators 22 based on the difference in the value for the light reception information a1-d1 among some of the photosensors 122 by which the reference value is obtained and the other photosensors 122 may be saved into the backlight unit controller 240 in advance. In such a case, the backlight unit controller 240 can accurately control the irradiators 22 based on a luminance distribution of external light irradiating each of the areas A-D.

The backlight unit controller 240 may obtain a difference in a value for the light reception information a1-d1 obtained by the same photosensors 122 at a plurality of preset timings, and control each of the irradiators 22 based on the difference in the value for the light reception information a1-d1.

In such a case, settings for, e.g., the suitable brightness of the irradiators 22 based on the foregoing difference and the timing at which the light reception information a1-d1 obtained by the photosensors 122 is referred may be saved into the backlight unit controller 240 in advance. Thus, the backlight unit controller 240 can accurately control the irradiators 22 based on a chronological change in value for the light reception information a1-d1 obtained by the photosensors 122.

When external light irradiating the display region 10a is temporarily blocked by, e.g., an individual passing in front of the LCD, a significant change in value for the light reception information a1-d1 obtained by the photosensors 122 temporarily occurs. If the irradiators 22 are controlled based on the light reception information a1-d1 obtained in the foregoing state, the brightness of illumination light is needlessly adjusted. If such unnecessary adjustment of illumination light is performed, there is a possibility that image defects such as image flickering occur.

In order to prevent the foregoing defects, if certain values for the light reception information a1-d1 are constantly and continuously obtained by the photosensors 122 for a predetermined period of time, the backlight unit controller 240 may control each of the irradiators 22 based on such values for the light reception information a1-d1. According to such a configuration, even if the significant change in brightness of external light temporarily occurs, the unnecessary adjustment of the brightness of illumination light can be prevented, and the flickering of the display image can be reduced.

### Advantages of First Embodiment

According to the first embodiment, when the display region is irradiated with strong external light having the strength exceeding the reference value preset for the light reception information a1-d1 obtained by the photosensors 122, the graphic image 12 is displayed by the graphic display controller 250, and the viewer can perceive the information indicated by the graphic image 12. Thus, the stress on the viewer due to the viewer's difficulty of viewing an image can be reduced.

That is, it is difficult to view the display image in the region of the display region 10a where strong external light such as the sun light L enters. However, by displaying the graphic image 12 such as subtitles in the foregoing state, the viewer can perceive the information indicated by the graphic image 12. Thus, the stress on the viewer due to the viewer's difficulty of viewing an image can be reduced.

The graphic image 12 is displayed in the graphic display area 11 which is set in the region (i.e., the region which is not irradiated with the sun light L) of the display region 10a other than part of the display region 10a corresponding to one or more of values for the light reception information a1-d1 exceeding the reference value. Thus, the viewer can more easily view the graphic image 12. In addition, since the dimensions of the graphic image 12 are increased or decreased depending on the graphic display area 11, the entirety of the graphic image 12 can be viewed in suitable dimensions.

Since the graphic image 12 indicates the information relating to the contents of an image displayed in the display region 10a, the graphic image 12 compensates for the information of the display image. Thus, stress on the viewer viewing the display image can be further reduced.

Conversely, the graphic image 12 may indicate another type of information which does not relate to the contents of the display image. In such a case, since the viewer can perceive the another type of information by the graphic image instead of the less-perceivable display image, the stress on the viewer due to the viewer's difficulty of viewing an image can be reduced.

By controlling the irradiators 22 of the backlight unit 20 in one or more of the areas A-D including the graphic display area 11, the luminance of the irradiators 22 is increased. Thus, the graphic image 12 can be more easily viewed.

### Second Embodiment of the Invention

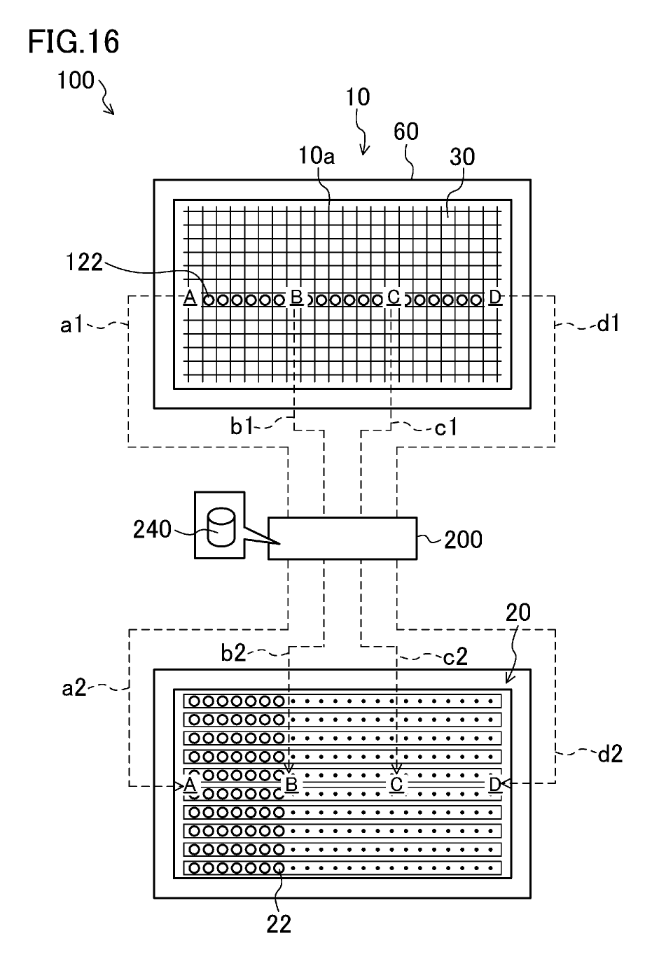

FIGS. 16-26 illustrate a second embodiment of the present invention. Note that the same reference numerals as those shown in FIGS. 1-15 are used to represent equivalent elements in each of the following embodiments, and the description thereof will not be repeated.

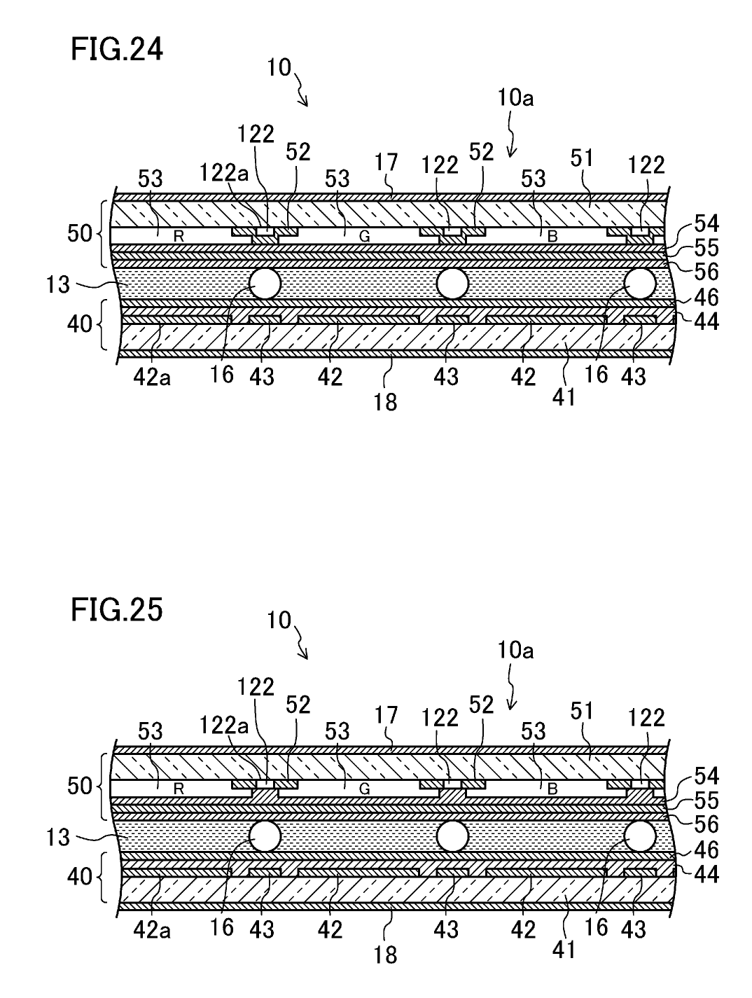

FIGS. 16-23 are LCD block diagrams schematically illustrating variations of arrangement of photosensors. FIGS. 24-26 are enlarged cross-sectional view illustrating a structure of a liquid crystal panel.

Photosensors 122 may be arranged so that external light irradiating a liquid crystal panel 10 can be received at a plurality of positions of a display region 10a. Arrangement positions of the photosensors 122 are exemplified below.

For example, the photosensors 122 may be arranged so as to be dispersed along a line horizontally or vertically extending across the display region 10a. Thus, light reception information of external light irradiating the display region 10a can be obtained along the line horizontally or vertically extending across the display region 10a. In such a case, e.g., the brightness of external light can be detected along the line horizontally or vertically extending across the display region 10a. In this case, the number of the photosensors 122 can be reduced as compared to the case where the photosensor 122 is arranged at each pixel group including a plurality of pixels.

Thus, circuits and wiring for obtaining the light reception information of external light can be simplified, and a manufacturing cost can be kept low. The aperture ratio of a pixel 30 at which the photosensor 122 is arranged decreases. However, by reducing the number of the photosensors 122 as described above, the decrease in aperture ratio of the pixel 30 can be reduced across the entirety of the display region 10a. Thus, a decrease in luminance of a display image can be reduced.

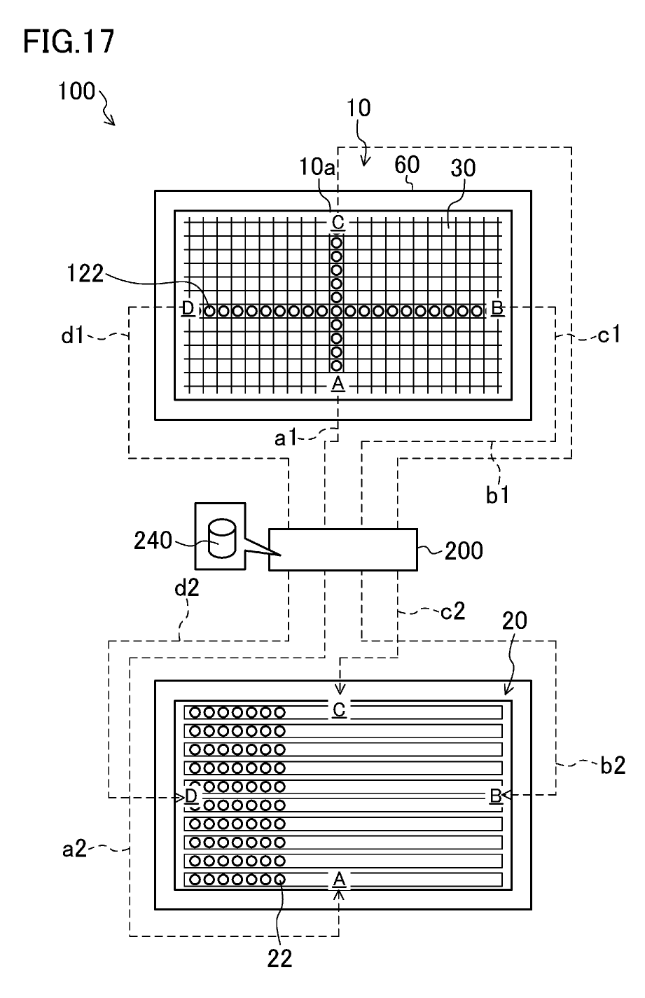

Referring to FIGS. 16 and 17, in, e.g., the case where the display region 10a is in a rectangular shape, the photosensors 122 may be arranged in the display region 10a along a line connecting midpoints of at least two of four side edges of the display region 10a facing each other. In such a case, the photosensors 122 can obtain, along the line connecting the midpoints, light reception information a1-d1 of external light irradiating the display region 10a.

Alternatively, referring to FIG. 16, the photosensors 122 may be arranged along a line connecting midpoints of two side edges in a transverse direction of the rectangular display region 10a. In such a case, light reception information a1-d1 of external light in a longitudinal direction of the rectangular display region 10a can be obtained. Thus, the light reception information a1-d1 in which a luminance distribution of external light irradiating the entirety of the display region 10a is substantially reflected can be obtained.

In order to accurately obtain light reception information a1-d1 of external light in the transverse direction of the display region 10a, some of the photosensors 122 may be, referring to FIG. 17, arranged along the line connecting the midpoints of the two side edges in the transverse direction of the display region 10a, and the other photosensors 122 may be arranged along a line connecting midpoints of the other two side edges in the longitudinal direction of the display region 10a.

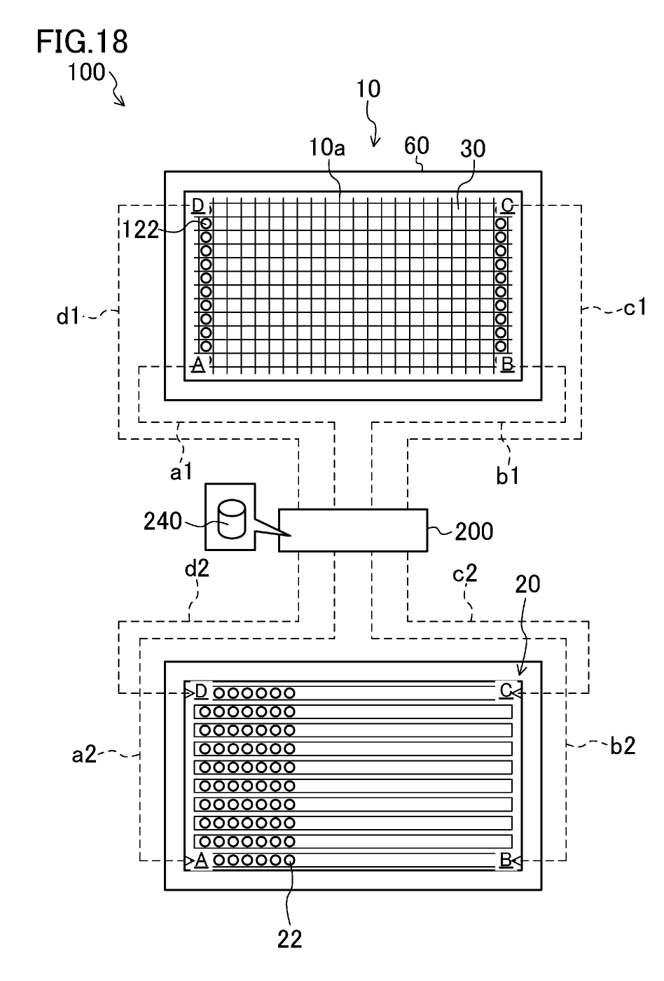

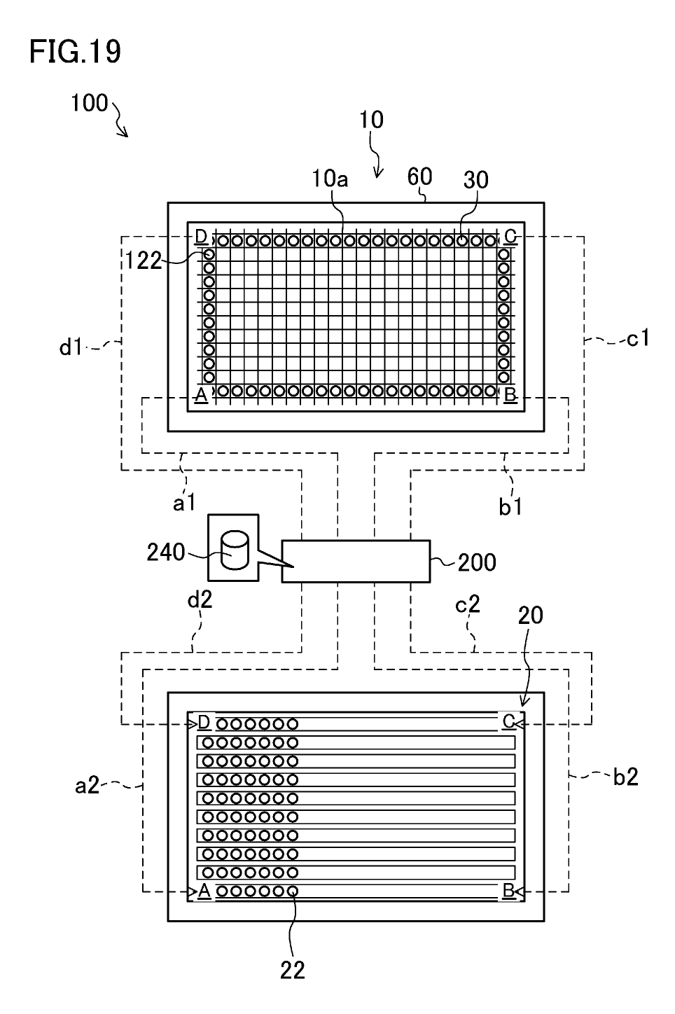

Referring to FIGS. 18 and 19, in a peripheral part of the display region 10a, the photosensors 122 may be arranged along at least two of four side edges of the display region 10a facing each other.

If the photosensors 122 are arranged in a center part of the display region 10a and the luminance of a display image is decreased in the center part of the display region 10a, a user is likely to perceive the decrease in luminance of the display image. On the other hand, since the photosensors 122 are arranged in the peripheral part of the display region 10a as described above, the user is less likely to perceive the decrease in luminance of the display image as compared to the case where the photosensors 122 are arranged in the center part of the display region 10a.

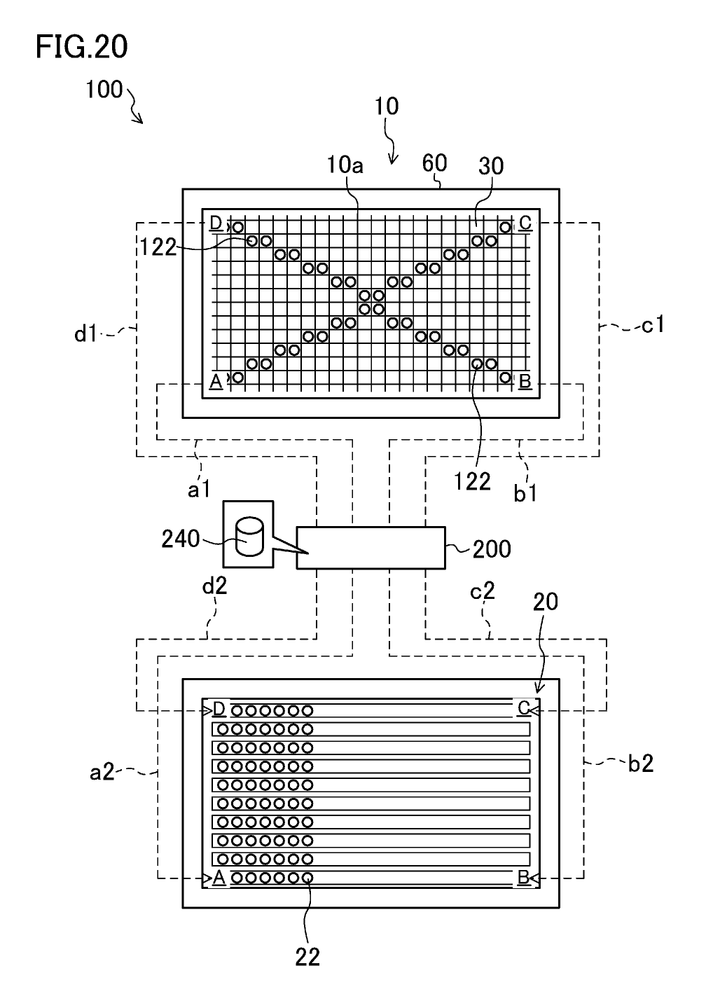

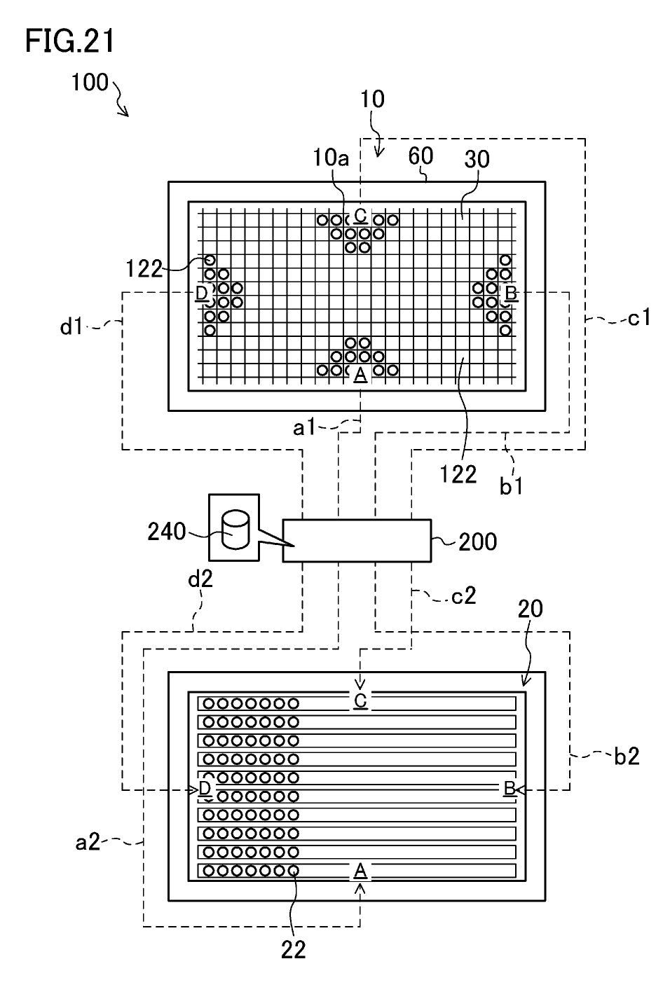

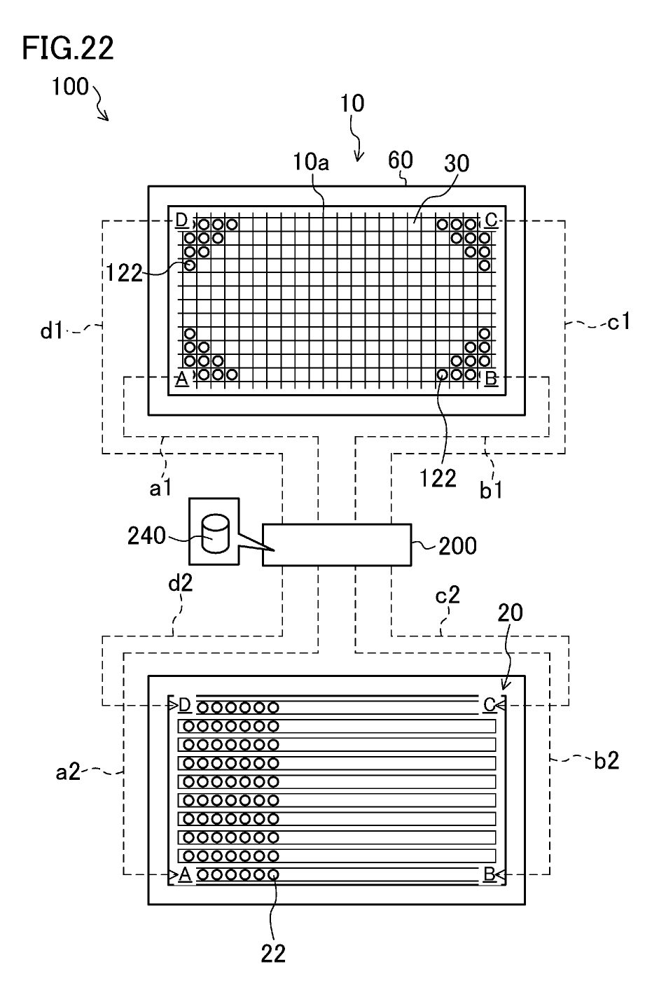

The photosensors 122 may be arranged in other positions of the liquid crystal panel 10 as viewed in the plane. For example, referring to FIG. 20, the photosensors 122 may be arranged along at least one of diagonal lines of the display region 10a. Alternatively, referring to FIG. 21, the photosensors 122 may be arranged at the middle of each side edge in the peripheral part of the display region 10a. As another alternative, the photosensors 122 may be, referring to FIG. 22, arranged at each corner of the peripheral part of the display region 10a.

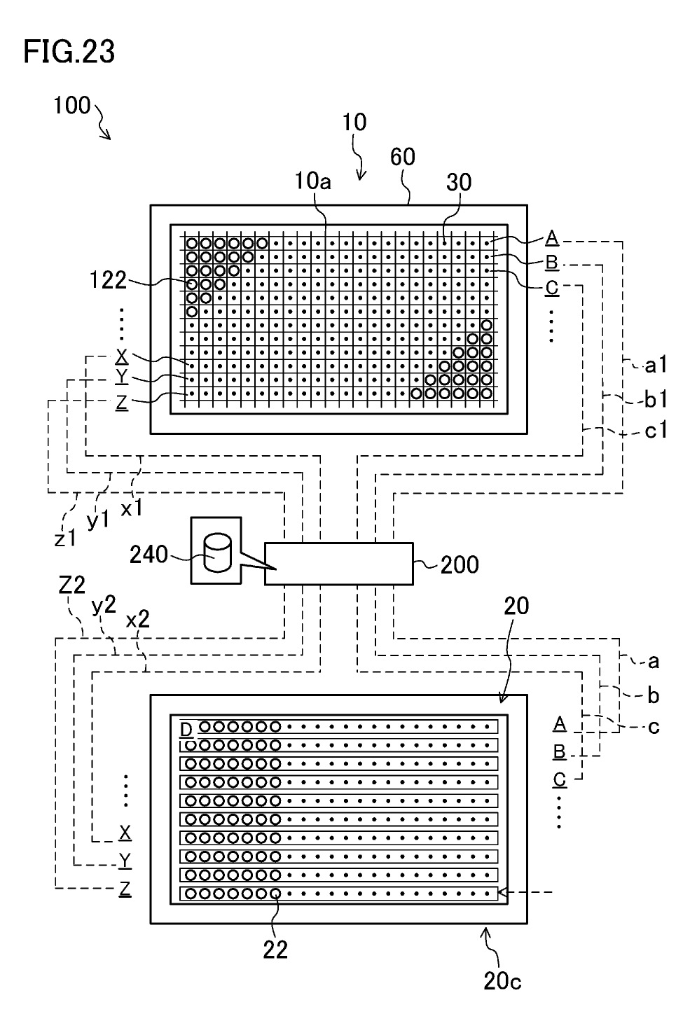

In the foregoing embodiment, the display region 10a is divided into the four areas A, B, C, and D. However, the number of divided areas of the display region 10a is not limited to four, and may be changed as necessary depending on an intended use. For example, referring to FIG. 23, a plurality of divided areas A-Z of the display region 10a may be set corresponding to the arrangement positions of the photosensors 122. In such a case, an irradiator 22 may be arranged corresponding to each of the positions of the areas A-Z (photosensors 122) and may be controlled. In this case, a backlight unit controller 240 can control, based on light reception information a1-z1 obtained by the photosensors 122, each of the irradiators 22 for which the areas A-Z are respectively set.

In each of the pixels 30, an aperture is formed, through which illumination light emitted from a backlight unit 20 to irradiate a rear surface of the liquid crystal panel 10 and external light irradiating the display region 10a pass. In such a case, a black matrix 52 is formed in a grid pattern so as to extend along a region of the liquid crystal panel 10 between adjacent ones of the apertures as viewed in the plane, and blocks illumination light and external light.

Each of the photosensors 122 may be arranged on the front side of the liquid crystal panel 10 relative to the black matrix 52 in a region where the black matrix 52 is formed as viewed in plane of the liquid crystal panel 10. In such a case, the photosensor 122 can be arranged within a region where the pixel 30 is formed, without covering the aperture of the pixel 30. Thus, the decrease in aperture ratio of the pixel 30 can be reduced.

A specific example in the case where the photosensors 122 are arranged in the region of the liquid crystal panel 10 where the black matrix 52 is formed as viewed in the plane will be described below.

For example, each of the photosensors 122 may be, referring to FIG. 24, arranged so as to be covered by the black matrix 52 on a side closer to the backlight unit 20. Thus, since illumination light emitted from the backlight unit 20 is blocked by the black matrix 52 before the photosensors 122 receive the illumination light, light reception information a1-d1 which does not contain information of the illumination light can be obtained by the photosensors 122.

Referring to FIG. 25, each of the photosensors 122 may be arranged in the black matrix 52.

The photosensors 122 may be arranged in a region of the liquid crystal panel 10 where TFTs 47 and signal lines 43 are formed as viewed in the plane. Since the TFTs 47 and the signal lines 43 have light blocking properties, illumination light from the backlight unit 20 is blocked by the TFTs 47 and the signal lines 43. Since the photosensors 122 arranged in the region where the TFTs 47 and the signal lines 43 are formed are arranged in a region where illumination light is already blocked, the aperture ratio of the pixel 30 does not decrease. Thus, the arrangement of the photosensors 122 can reduce or prevent the decrease in luminance of a display image.

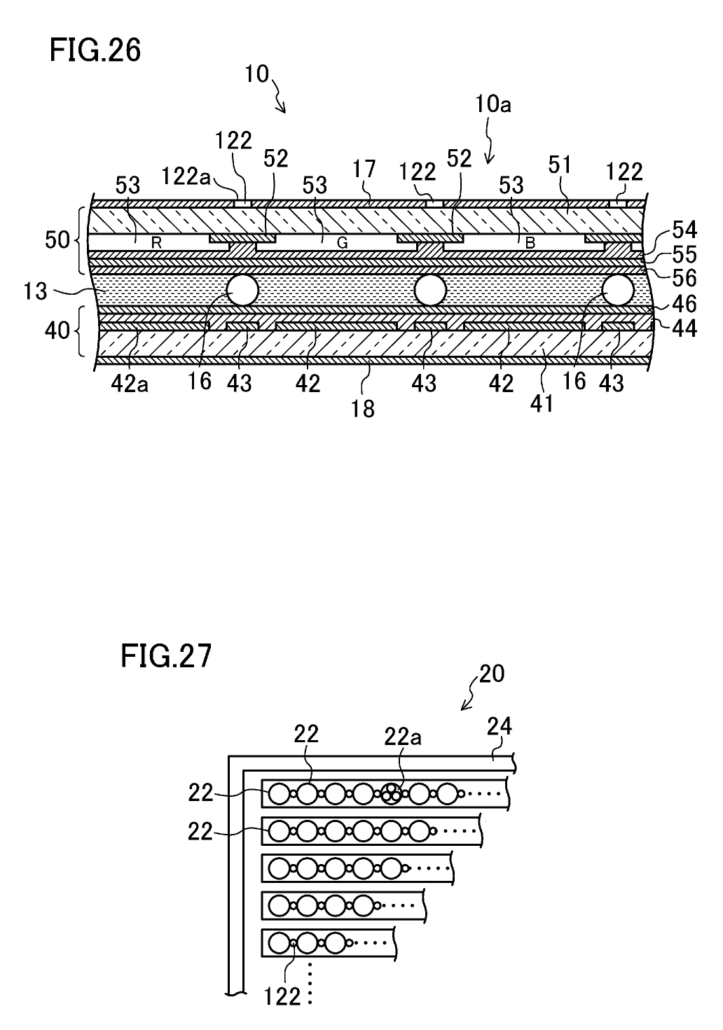

The photosensors 122 are not necessarily arranged inside the liquid crystal panel 10 as described above. For example, referring to FIG. 26, the photosensors 122 may be arranged in a polarizer 17 attached to a front surface of the liquid crystal panel 10. Even in such a case, the photosensors 122 can receive external light irradiating the liquid crystal panel 10. If the photosensors 122 are arranged in the polarizer 17, the photosensors 122 may be arranged in the region of the liquid crystal panel 10 where the black matrix 52 is formed as viewed in the plane. Since light is already blocked in the region where the black matrix 52 is formed, the arrangement of the photosensors 122 in the region where the black matrix 52 is formed allows the arrangement of the photosensors 122 without the decrease in aperture ratio of the pixel 30.

The photosensors 122 may be arranged in a member other than the liquid crystal panel 10.

For example, referring to FIG. 27 which is an enlarged plan view schematically illustrating the backlight unit, the photosensors 122 may be arranged in the backlight unit 20. In such a case, since the photosensors 122 can be arranged in the display region 10a without each of the apertures of the pixels 30 of the liquid crystal panel 10 being covered, the decrease in aperture ratio of the pixel 30 can be reduced or prevented.

The photosensors 122 may be arranged between the liquid crystal panel 10 and the backlight unit 20. In such a case, since the photosensors 122 are not directly provided in the liquid crystal panel 10 or the backlight unit 20, the photosensors 122 can be provided without changing the structures of the liquid crystal panel 10 and the backlight unit 20.

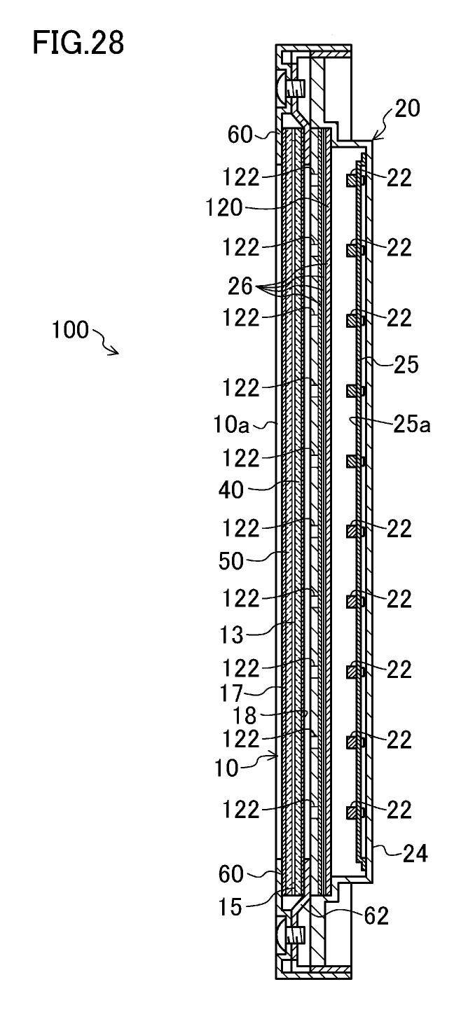

Referring to FIG. 28 which is a longitudinal sectional view of an LCD, the photosensors 122 may be arranged in an photosensor support member 120 sandwiched between the liquid crystal panel 10 and the backlight unit 20. The photosensor support member 120 is preferably a transparent substrate having light permeability, and an optical sheet 26 sandwiched between the liquid crystal panel 10 and the backlight unit 20 can be used.

If the photosensor support member 120 is used, the photosensors 122 can be arranged in part where the photosensors 122 cannot be arranged in the case of the arrangement in the liquid crystal panel 10 or the backlight unit 20. Thus, the degree of freedom of an photosensor layout can be improved.

If the photosensors 122 are arranged in the photosensor support member 120, a plurality of photosensor support members 120 which is different from each other in an arrangement pattern of the photosensors 122 may be provided. Thus, the arrangement of the photosensors 122 can be changed by replacing any of the photosensor support members 120 with another photosensor support member 120. Consequently, the positions of the photosensors 122 can be easily changed depending on an intended use (e.g., for a television broadcasting receiver and for an information display) of an LCD 100.

### Third Embodiment of the Invention

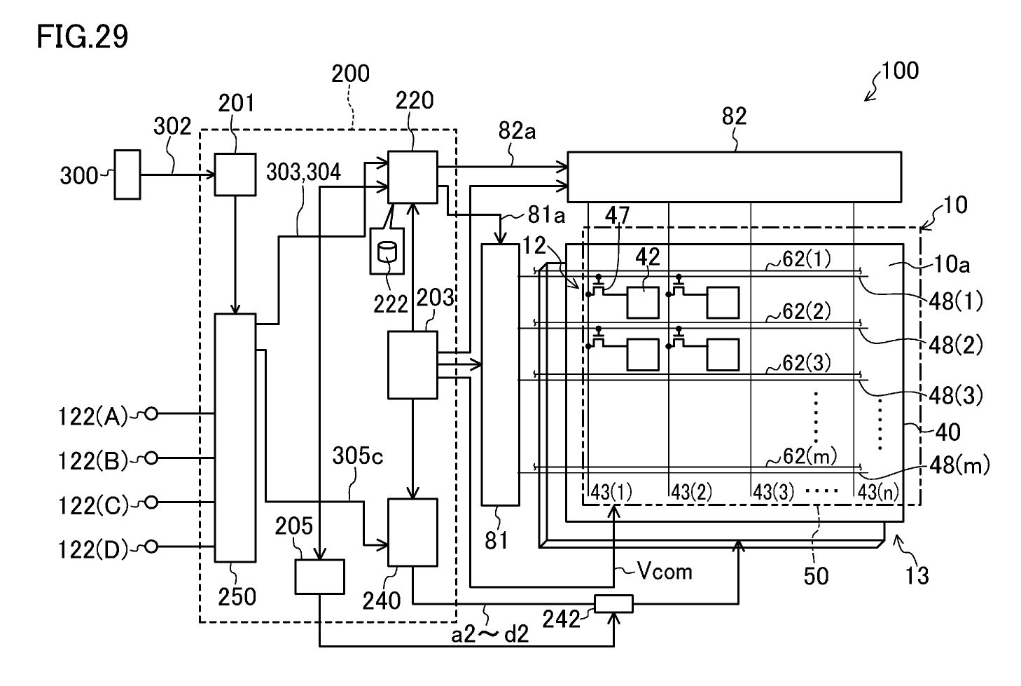

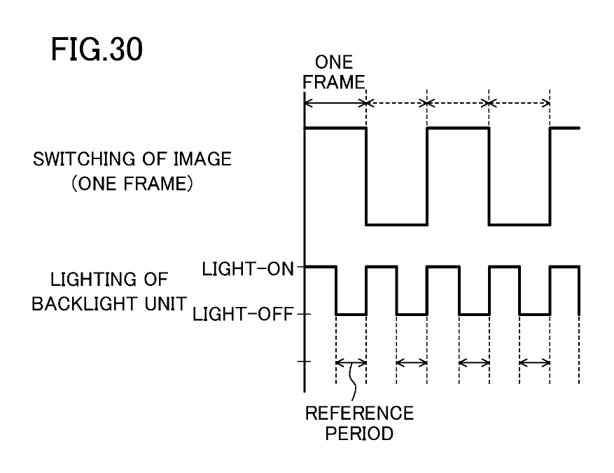

FIGS. 29 and 30 illustrate a third embodiment of the present invention.

FIG. 29 is a block diagram schematically illustrating a wiring structure and a controller in an LCD of the third embodiment. FIG. 30 is a timing chart illustrating intermittent driving of a backlight unit.

An LCD 100 of the third embodiment is configured such that a backlight unit 20 is intermittently driven in the configuration of the first embodiment.

The LCD 100 includes an intermittent drive controller 205 configured to alternately switch between a light-off period for which the backlight unit 20 is turned off and a light-on period for which the backlight unit 20 is turned on such that the backlight unit 20 is at the light-off period while an image displayed in the display region 10a is being switched to another image.

Referring to FIG. 29, the intermittent drive controller 205 is provided as part of a controller 200. A liquid crystal panel control signal 205a is input from a liquid crystal panel controller 220 to the intermittent drive controller 205. The intermittent drive controller 205 detects, based on the liquid crystal panel control signal 205a, an image switching period for which a display image is being switched, generates a light-off signal 242a based on the image switching period, and sends the light-off signal 242a to a power controller 242.

The power controller 242 is configured to stop, based on the light-off signal 242a, a power supply to irradiators 22 during a predetermined period of the image switching period (one frame). Thus, referring to FIG. 30, each of the irradiators 22 of the backlight unit 20 is controlled such that the backlight unit 20 is at the light-off period during one frame.

A graphic display controller 250 may control a display of a graphic image 12 based on light reception information a1-d1 obtained by photosensors 122 during the light-off period of the backlight unit 20. In such a state, a setting for a reference period for which the light reception information a1-d1 obtained by the photosensors 122 is referred is, referring to FIG. 30, saved into the graphic display controller 250 in advance. The reference period is set so as to be in the same time period as the light-off period of the backlight unit 20.

The light reception information a1-d1 obtained during the light-off period of the backlight unit 20 as described above does not contain information of illumination light emitted from the backlight unit 20. The graphic display controller 250 accurately controls, based on the light reception information which does not contain the information of illumination light, the display of the graphic image 12 which is reflective of a distribution of external light irradiating the display region 10a.

The graphic display controller 250 may control the display of the graphic image 12 based on light reception information a1-d1 obtained by the photosensors 122 during the light-on period and a difference among values for the light reception information a1-d1 obtained by the photosensors 122 during the light-on period and values for the light reception information a1-d1 obtained by the photosensors 122 during the light-off period.

In such a case, the graphic display controller 250 obtains the difference among the values for the light reception information a1-d1 obtained during the light-on period and the values for the light reception information a1-d1 obtained during the light-off period, thereby calculating values for the light reception information a1-d1 of illumination light. Then, the graphic display controller 250 controls the display of the graphic image 12 based on the calculated values for the light reception information a1-d1 of illumination light and the light reception information a1-d1 obtained by the photosensors 122. Thus, the display of the graphic image 12 can be controlled based on the current brightness of illumination light. Consequently, even if the brightness of illumination light emitted from the irradiators 22 is changed in association with, e.g., a change in surrounding temperature and degradation over time, the display of the graphic image 12 can be suitably controlled.

### Fourth Embodiment of the Invention

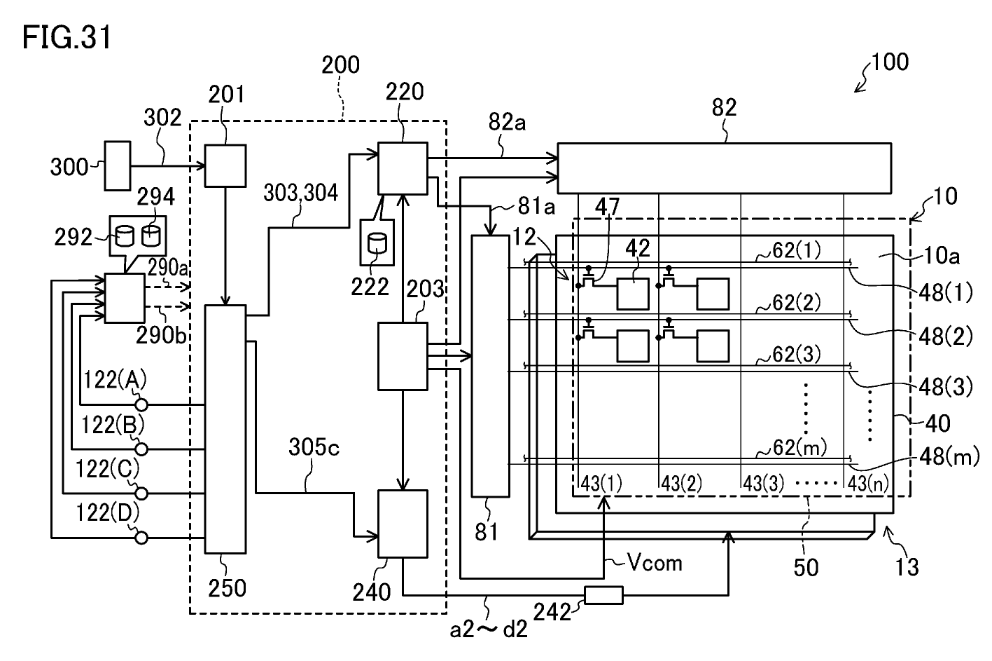

FIG. 31 illustrates a fourth embodiment of the present invention.

FIG. 31 is a block diagram schematically illustrating a wiring structure and a controller in an LCD of the fourth embodiment.

An LCD 100 of the fourth embodiment includes a switcher 290 in the configuration of the first embodiment. The switcher 290 is configured to switch between a graphic display mode in which a graphic image is displayed by a graphic display controller 250 and a graphic non-display mode in which the graphic display mode is not executed by the graphic display controller 250. The graphic display controller 250 is configured to perform a control for displaying the graphic image 12 described above in the case where the graphic display mode is set.

Referring to FIG. 31, the switcher 290 is connected to a controller 200. The switcher 290 generates a control stop signal 290a for stopping a control of the controller 200 and a control start signal 290b for starting the control of the controller 200 depending on the switching between the graphic display mode and the graphic non-display mode. Then, the switcher 290 sends the control stop signal 290a or the control start signal 290b to the controller 200. When the control stop signal 290a is transmitted from the switcher 290 to the controller 200, the controller 200 is switched from the graphic display mode to the graphic non-display mode. On the other hand, when the control start signal 290b is transmitted, the controller 200 is switched from the graphic non-display mode to the graphic display mode.

Referring to FIG. 31, the LCD 100 includes a timer 292 connected to the switcher 290. A setting for a time period for which the control according to the graphic display mode is performed is saved into the timer 292 in advance. The switcher 290 switches between the graphic display mode and the graphic non-display mode based on the preset time period saved into the timer 292.

The switcher 290 switches the controller 200 to the graphic display mode only at a time period for which the intensity of external light irradiating a display region 10a is high or a time period for which the intensity of external light is likely to change. For example, the preset time period saved into the timer 292 may be a time period for which the intensity of external light is likely to change during the day. Thus, power constantly consumed during the graphic display mode can be reduced during the graphic non-display mode.

Referring to FIG. 31, the switcher 290 may switch between the graphic display mode and the graphic non-display mode based on light reception information a1-d1 obtained by photosensors for switching. The photosensors for switching are photosensors configured to receive external light irradiating a liquid crystal panel 10 respectively at a plurality of positions of the display region 10a. As the photosensors for switching, the foregoing photosensors 122 are used. Note that photosensors other than the photosensor 122 may be arranged in the LCD 100 as the photosensors for switching.

In the LCD 100 illustrated in FIG. 31, a switching controller 294 is connected to the switcher 290. Light reception information a1-d1 obtained by the photosensors 122 is sent to the switching controller 294. The switching controller 294 generates a switching control signal based on the light reception information a1-d1 obtained by the photosensors 122, and then sends such a signal to the switcher 290.

The switcher 290 generates, based on the switching control signal, a control stop signal 290a or a control start signal 290b, and switches between the graphic display mode and the graphic non-display mode. Thus, the LCD 100 can select the graphic display mode when the intensity of external light irradiating the display region 10a changes, and select the graphic non-display mode when the intensity of external light does not change.

In the graphic display mode in which the control by the graphic display controller 250 is performed based on the light reception information a1-d1 obtained by the photosensors 122, the LCD 100 constantly consumes power for performing such a control. On the other hand, in the graphic non-display mode, the control for displaying the graphic image 12 based on the light reception information a1-d1 obtained by the photosensors 122 can be performed only when needed. Thus, power consumption can be kept low.

In the LCD 100, since the photosensors 122 are also used as the photosensors for switching, the number of photosensors can be reduced as compared to the case where the photosensors for switching are separately provided. Thus, the following can be reduced or prevented: a decrease in luminance of a display image due to covering of a pixel 30 by the photosensor for switching; and an increase in component cost due to attachment of additional components.

### Fifth Embodiment of the Invention

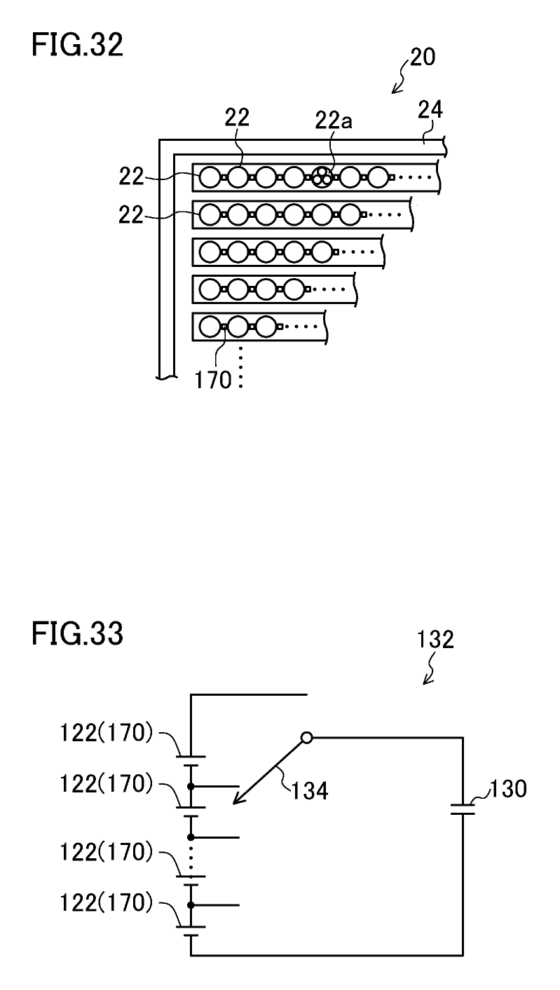

FIG. 32 illustrates a fifth embodiment of the present invention.

FIG. 32 is an enlarged plan view schematically illustrating a backlight unit of the fifth embodiment.

An LCD 100 may include temperature sensors 170 in addition to photosensors such as photosensors 122. The temperature sensors 170 may be arranged respectively at, e.g., a plurality of positions of a backlight unit 20, and may be elements configured to generate thermoelectric power.

Each of the temperature sensors 170 is configured to detect the temperature of the backlight unit 20 in each area. Each of the temperature sensors 170 is connected to a backlight unit controller 240, and the detected temperature in each area is sent to the backlight unit controller 240. The backlight unit controller 240 is configured to control each of irradiators 22 based on light reception information a1-d1 obtained by the photosensors 122 and the temperature of the backlight unit 20 obtained for each area by the temperature sensor 170.

As described above, the irradiators 22 are susceptible to a change in surrounding temperature. In response, in the LCD 100 of the present embodiment, the brightness of the irradiators 22 can be corrected based on the temperature of the backlight unit 20 obtained by the temperature sensors 170 while each of the irradiators 22 can be suitably controlled based on the light reception information a1-d1 obtained by the photosensors 122.

### Sixth Embodiment of the Invention

FIG. 33 illustrates a sixth embodiment of the present invention.

FIG. 33 is a diagram of a circuit for using electromotive force generated by photosensors.

If photosensors 122 are elements each configured to generate photovoltaic power, the electromotive force generated by each of the photosensors 122 can be used as power for driving an LCD 100. In order to use electromotive force as power for driving the LCD 100, the LCD 100 may include a power storage 130 configured to store electromotive power generated by the photosensors 122.

As the foregoing elements capable of generating photovoltaic power, e.g., photodiodes and phototransistors are used. Each of the photosensors 122 may be connected to the power storage 130 in an electric circuit 132 illustrated in FIG. 33. The electric circuit 132 includes a multiplexer 134. Electromotive force generated by the photosensors 122 is gathered into a single circuit by the multiplexer 134, and then is stored in the power storage 130. The power storage 130 is also connected to a power source 203 etc., and stored electromotive force is used as voltage to be applied to a liquid crystal panel 10 and other types of power. This saves power for driving the LCD 100.

Even if driving of the LCD 100 is stopped, the photosensors 122 are irradiated with external light, and electromotive force is generated. Thus, in the LCD 100, electromotive force generated during the stoppage of the driving of the LCD 100 is stored in the power storage 130, thereby further saving power for driving the LCD 100. In particular, the LCD 100 can be preferably used for, e.g., an information display which is often placed outside and is irradiated with a large amount of external light during the day.

In the LCD 100 including the power storage 130, the photosensors 122 may be arranged in such positions that both of external light irradiating a display region 10a and illumination light emitted from a backlight unit 20 can receive. In such a case, the power storage 130 can store not only external light irradiating the display region 10a but also illumination light emitted from the backlight unit 20.

If the foregoing temperature sensors 170 are elements each configured to generate thermoelectric power, power generated by the temperature sensors 170 can be stored in the power storage 130, and the stored power can be used to drive the LCD 100. In such a case, a larger amount of power can be stored, and the stored power can be used to drive the LCD 100.

### Seventh Embodiment of the Invention

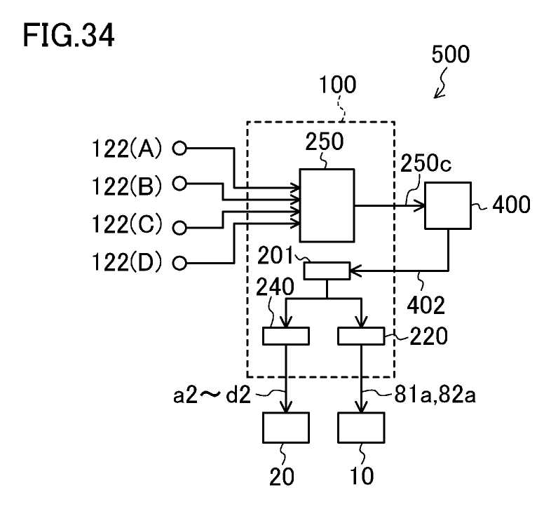

FIG. 34 illustrates a seventh embodiment of the present invention.

FIG. 34 is a block diagram schematically illustrating an image display system which is, e.g., a digital signage system.

Next, a display device such as an LCD 100, a graphic display controller 250 provided in the display device, and an image display system 450 including an external processing device 400 will be described.

The LCD 100 includes, as in the first embodiment, a liquid crystal panel 10 in which a plurality of photosensors 122 are dispersively arranged. The external processing device 400 is configured to generate an image signal 402 for displaying an image in a display region 10a, and send the image signal 402 to the LCD 100. As the external processing device 400, e.g., a personal computer (PC) including a processing device such as a CPU can be used.

In the graphic display controller 250, a reference value is preset for light reception information a1-d1 obtained by the photosensors 122. If one or more of values for the light reception information a1-d1 exceeding the reference value is obtained by the photosensors 122, the graphic display controller 250 displays, based on the light reception information a1-d1, a graphic image 12 indicating predetermined information in the display region 10a.

Referring to FIG. 34, the light reception information a1-d1 obtained by the photosensors 122 is input to the graphic display controller 250. If one or more of values for the light reception information a1-d1 exceeds the reference value preset in the graphic display controller 250, the graphic display controller 250 generates a graphic control signal 250c based on the light reception information a1-d1. The graphic control signal 250c is sent to the external processing device 400. The external processing device 400 newly generates, based on the input graphic control signal 250c, an image signal 402 containing information relating to a display image and information relating to the graphic image 12.

The image signal 402 is sent from the external processing device 400 to the LCD 100, and then is input to a liquid crystal panel controller 220 and a backlight unit controller 240 through a signal inputter 201. The liquid crystal panel controller 220 controls the liquid crystal panel 10 based on the image signal 402.

Note that, in the image display system 450, the graphic display controller 250 is not necessarily embedded in the LCD 100. For example, the graphic display controller 250 may be embedded in the external processing device 400. Alternatively, if the image display system 450 includes a device other than the LCD 100 and the external processing device 400, the graphic display controller 250 may be provided in such a device.

According to the image display system 450, when the display region is irradiated with strong external light having strength exceeding the reference value preset for the light reception information a1-d1 obtained by the photosensors 122, a viewer can perceive the information indicated by the graphic image 12, and therefore stress on the viewer due to viewer's difficulty of viewing an image can be reduced.

### Eighth Embodiment of the Invention

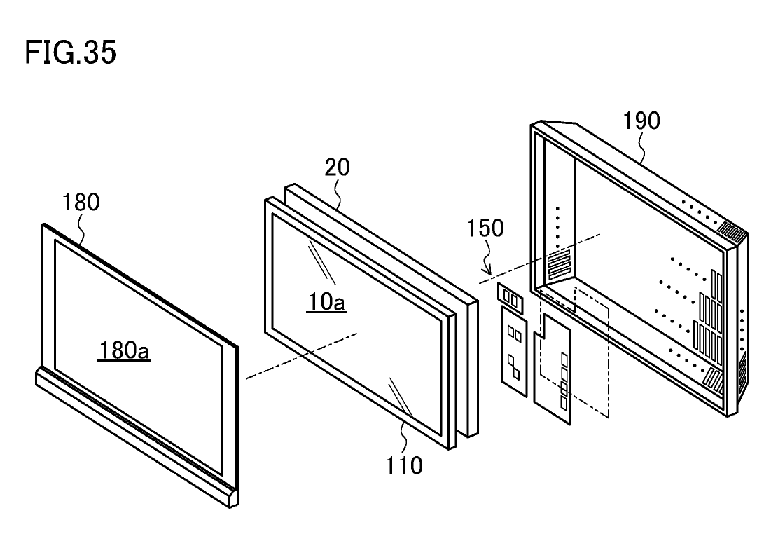

FIGS. 35-37 illustrate an eighth embodiment of the present invention.

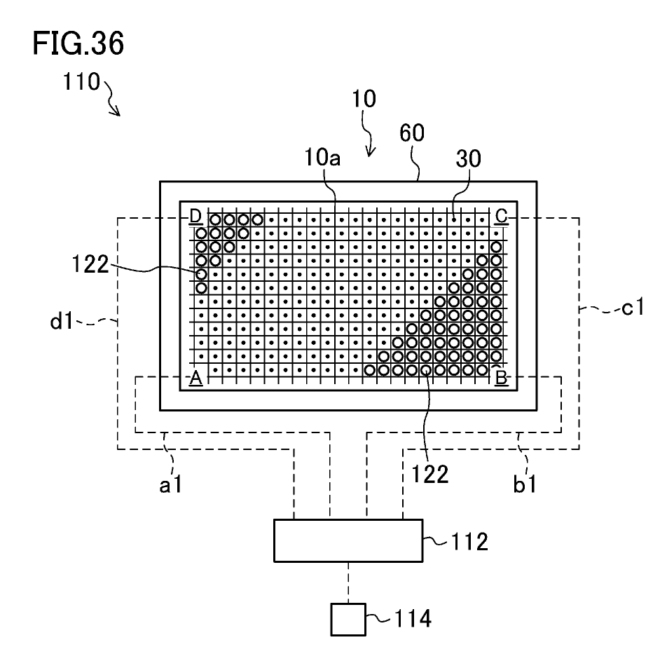

FIG. 35 is an exploded perspective view illustrating a schematic configuration of an LCD. FIG. 36 is a bock diagram schematically illustrating a liquid crystal module.

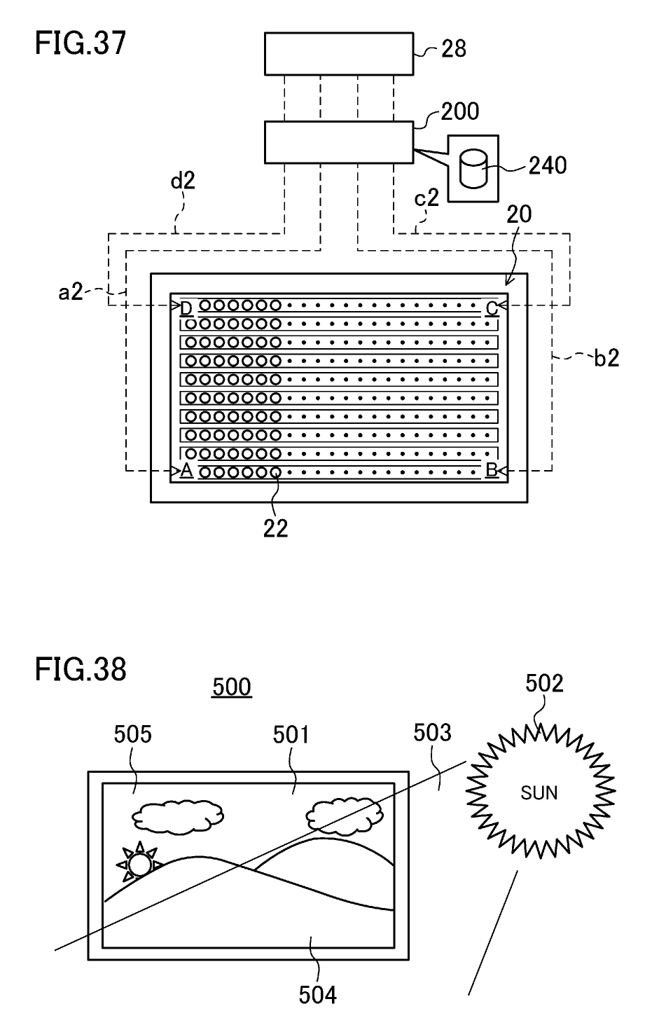

FIG. 37 is a block diagram schematically illustrating a backlight unit.

For example, referring to FIG. 35, an LCD 100 is accommodated in the state in which the LCD 100 is sandwiched between a first housing 180 and a second housing 190. An opening 180a corresponding to a display region 10a is formed in the first housing 180. The second housing 190 covers a rear surface of the LCD 100, and a circuit 150 configured to operate the LCD 100 is mounted on the second housing 190. Note that a use for the LCD 100 is not limited to a digital signage, and the LCD 100 can be applied to other image display devices such as television receivers.

When the LCD 100 is manufactured, a liquid crystal module 110 is formed in a manufacturing process. The liquid crystal module 110 is arranged so as to face a backlight unit 20 and forms the LCD 100. Referring to FIG. 36, the liquid crystal module 110 includes a liquid crystal panel 10 having the display region 10a in which a plurality of pixels are arranged, a plurality of photosensors 122, an operator 112, and an output terminal 114.

The photosensors 122 are dispersively arranged in the display region 10a of the liquid crystal panel 10 such that the display region 10a of the liquid crystal panel 10 receives external light input from a side opposite to the backlight unit 20. The operator 112 is configured to generate, based on light reception information a1-d1 obtained by the photosensors, a control signal for controlling, e.g., a graphic display and illumination light irradiating an area including a graphic display area 11. The output terminal 114 is configured to output the control signal generated by the operator 112.

By using the liquid crystal module 110, the LCD 100 which is capable of controlling a display of a graphic image 12 based on the light reception information a1-d1 obtained by the photosensors 122 can be manufactured.

The output terminal 114 may be connected to a graphic display controller 250, and the liquid crystal module 110 including the graphic display controller 250 may be formed. In such a case, in the graphic display controller 250, a reference value is preset for the light reception information a1-d1 obtained by the photosensors 122. If one or more of values for the light reception information a1-d1 exceeding the reference value is obtained by the photosensors 122, the graphic image 12 indicating predetermined information is displayed in the display region 10a based on the light reception information a1-d1.

In the manufacturing process of the LCD 100, a backlight unit 20 illustrated in FIG. 37 is also formed. Referring to FIG. 37, the backlight unit 20 includes a plurality of irradiators 22, an input terminal 28, and a backlight unit controller 240. The light reception information a1-d1 obtained by the photosensors 122 is input to the input terminal 28. The backlight unit controller 240 is configured to control each of the irradiators 22 based on the light reception information a1-d1 input from the input terminal 28 such that the brightness of illumination light is partially adjusted. For example, the backlight unit 20 is configured such that the input terminal 28 is connected to the photosensors 122 through the output terminal 114, and therefore the LCD 100 which is capable of controlling each of the irradiators 22 based on the light reception information a1-d1 obtained by the photosensors 122 can be manufactured.

A backlight unit 20 including the graphic display controller 250 may be formed. In such a case, in the graphic display controller 250, a reference value is preset for the light reception information a1-d1 obtained by the photosensors 122. If one or more of values for the light reception information a1-d1 exceeding the reference value is obtained by the photosensors 122, the graphic display controller 250 controls the irradiators 22 based on the light reception information a1-d1.

Unless otherwise mutually inconsistent with each other, the foregoing embodiments can be combined together as necessary.

### INDUSTRIAL APPLICABILITY

As described above, the present invention is useful for the display device, the liquid crystal module, and the image display system.

### DESCRIPTION OF REFERENCE CHARACTERS

L Sun Light (External Light)
10 Liquid Crystal Panel (Display Panel)
10a Display Region
10a1 Image Display Area
11 Graphic Display Area
12 Graphic Image
20 Backlight Unit
22 Irradiator
30 Pixel
52 Black Matrix
a1-d1 Light Reception Information
100 Liquid Crystal Display
110 Liquid Crystal Module
122 Photosensor, Photosensor for Switching
130 Power Storage
170 Temperature Sensor
205 Intermittent Drive Controller
240 Backlight Unit Controller
250 Graphic Display Controller
290 Switcher
292 Timer
400 External Processing Device
450 Image Display System

1. A display device comprising:
a display panel in which a plurality of pixels are arranged in a display region;
a plurality of photosensors each configured to receive external light irradiating the display region of the display panel; and
a graphic display controller in which a reference value is preset for light reception information obtained by the photosensors and which is configured to display, when one or more of values for the light reception information exceeding the reference value is obtained by the photosensors, a graphic image indicating predetermined information in the display region based on the light reception information.

2. The display device of claim 1, wherein
when a proportion of an area of part of the display region corresponding to the one or more of values for the light reception information exceeding the reference value to an entire area of the display region exceeds a certain proportion, the graphic display controller displays the graphic image.

3. The display device of claim 1, wherein
in a region of the display region other than the part of the display region corresponding to the one or more of values for the light reception information exceeding the reference value, the graphic display controller sets, based on the light reception information obtained by the photosensors, a graphic display area where the graphic image is displayed.

4. The display device of claim 3, wherein
the graphic display controller changes dimensions of the graphic image depending on the graphic display area.

5. The display device of claim 3, wherein
the graphic display controller divides, based on the light reception information obtained by the light reception sensors, the region of the display region other than the part of the display region corresponding to the one or more of values for the light reception information exceeding the reference value into a plurality of divided regions, and sets the graphic display area or an image display area in each of the divided regions.

6. The display device of claim 5, wherein
the graphic display controller detects coordinate information of the graphic display area by image analysis, and sets the image display area in a region of the display region other than the graphic display area and the part of the display region corresponding to the one or more of values for the light reception information exceeding the reference value.

7. The display device of claim 1, wherein
the graphic display controller displays the graphic image in a preset region of the display region.

8. The display device of claim 1, wherein
the graphic image indicates information relating to contents of a display image in the display region.

9. The display device of claim 1, wherein
the graphic image is subtitles.

10. The display device of claim 1, wherein
the graphic display controller displays the graphic image when one or more of values for the light reception information exceeding the reference value is obtained in a center part of the display region.

11. The display device of claim 1, further comprising:
a switcher configured to switch between a graphic display mode in which the graphic image is displayed by the graphic display controller and a graphic non-display mode in which the graphic display mode is not executed; and
a timer into which a setting for a time period for which the graphic display mode is executed is saved in advance,
wherein the switcher switches between the graphic display mode and the graphic non-display mode based on the time period saved into the timer.

12. (canceled)

13. The display device of claim 1, wherein
the photosensors are dispersively arranged in the display region.

14. The display device of claim 13, wherein
each of the photosensors is, as viewed in plane, arranged in a region of the display panel where each of the pixels is formed.

15. The display device of claim 1, further comprising:
a liquid crystal panel which is the display panel; and
a backlight unit arranged so as to face the liquid crystal panel and including an irradiator configured to emit illumination light.

16. The display device of claim 15, wherein
the photosensors are arranged inside the liquid crystal panel.

17. The display device of claim 16, wherein
apertures through which illumination light emitted from the backlight unit to the liquid crystal panel passes are formed respectively in the pixels,
a back matrix configured to block irradiation light is, as viewed in the plane, formed in a grid pattern so as to extend along a region of the liquid crystal panel between adjacent ones of the apertures, and
the photosensors are, as viewed in the plane, arranged in a region of the liquid crystal panel where the black matrix is formed.

18. The display device of claim 15, further comprising:
a backlight unit controller configured to adjust, for each of the divided regions of the display region, luminance of illumination light emitted from the backlight unit,
wherein the backlight unit controller increases the luminance of illumination light in some of the divided regions including the graphic display area.

19. The display device of claim 15, further comprising:
an intermittent drive controller configured to alternately switch between a light-off period for which the backlight unit is turned off and a light-on period for which the backlight unit is turned on,
wherein, when the intermittent drive controller switches the backlight unit to be at the light-off period, the graphic display controller displays the graphic image based on the light reception information obtained by the photosensors.

20-22. (canceled)

23. An image display system comprising:
a display device including a display panel in which a plurality of pixels are arranged in a display region;
an external processing device configured to generate an image signal for displaying an image in the display region and send the image signal to the display device;
a plurality of photosensors each configured to receive external light irradiating the display region of the display panel, and
a graphic display controller in which a reference value is preset for light reception information obtained by the photosensors and which is configured to display, when one or more of values for light reception information exceeding the reference value is obtained by the photosensors, a graphic image indicating predetermined information in the display region based on the light reception information.

24. A method for controlling a display panel in which a plurality of pixels are arranged in a display region, the method comprising:
a first step for obtaining, at a plurality of positions of the display region of the display panel, light reception information of external light irradiating the display region; and
a second step for displaying, when one or more of values for the light reception information exceeding a preset reference value is obtained at the first step, a graphic image indicating predetermined information in the display region based on the light reception information.
